(19) United States
(12) Patent Application Publication
(10) Pub. No.: US 2006/0187225 A1
(43) Pub. Date: Aug. 24, 2006

(54) Display driver

(75) Inventor: Yusuke Ota, Suwa (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/359,923

(22) Filed: Feb. 22, 2006

(30) Foreign Application Priority Data
Feb. 23, 2005 (JP) 2005-047291

(51) Int. Cl. G06T 1/60

(52) U.S. Cl. 345/530

(57) ABSTRACT

A display driver includes holding circuits outputting data of n bits (n≧2), a multiplexer receiving data output from the holding circuits and time sharingly outputting the data in normal operation, and a D/A converter, having converting input terminals, converting based on data of n bits input via the converting input terminals and outputting gray scale voltage, wherein each holding circuit includes latch circuits latching each bit data, the multiplexer includes multiplexer output terminals, and, during testing, each holding circuit serially outputs the holding circuit data as serial output from the output from the n-th latch circuit, the multiplexer time sharingly outputs the serial output from the n-th multiplexer output terminal, the serial output is input into each converting input terminal via the n-th multiplexer output terminal, and the D/A converter converts every time each bit data of the serial output is input into the converting input terminals.

### RELATED APPLICATIONS

This application claims priority to Japanese Patent Application No. 2005-047291 filed Feb. 23, 2005 which is hereby expressly incorporated by reference herein in its entirety.

### BACKGROUND

1. Technical Field

The present invention relates to a display driver.

2. Related Art

A display driver for driving a display panel undergoes various tests, such as the testing of operations, before being released as a product. Items to be tested in a display driver for driving a TFT panel include, for example, the drive voltage outputted from the display driver. In this case, as the drive voltage outputted from the product display driver is analog, the drive voltage undergoes D/A conversion so that the test may be carried out based on the converted digital data.

Meanwhile, display panels that meet recent demands for high resolution and high gray scale display are becoming widely used. A display driver, for example, for driving a TFT panel that is capable of high gray scale display outputs plural kinds of drive voltage based on the number of gray scale levels of the TFT panel. However, larger number of gray scale levels requires more number of corresponding drive voltage, which in turn requires accuracy in the D/A conversion of the drive voltage. This prevents manufacturing cost savings of the product. The time necessary for the D/A conversion during the test also prevents manufacturing cost savings of the product.

Further, as the increased number of drive voltages makes it difficult to precisely carry out D/A conversion on the drive voltage, there also arises a problem in that the carrying out of a highly precise test is precluded.

Moreover, in a test method such as described above, there arises another problem in that the test on the logic circuit part of the display driver cannot be carried out in the product test.

JP-A-6-235753 is an example of related art.

### SUMMARY

An advantage of the invention is to provide a display driver that enhances test accuracy and shortens test time.

A first aspect of the invention is to provide a display driver that includes first to m-th holding circuits (m is an integer greater than or equal to 2) each of which holds and outputs display data of n bits (n is an integer greater than or equal to 2) for at least one pixel, a multiplexer that receives display data for a plurality of pixels that is outputted from the first to the m-th holding circuits and outputs the display data for a plurality of pixels in a time-sharing way in the normal operation mode, and a D/A converter that, having first to n-th D/A converting input terminals, carries out D/A conversion based on data of n bits that is inputted via the first to the n-th D/A converting input terminals and outputs the output as a gray scale voltage. Here, each of the first to the m-th holding circuits includes first to n-th latch circuits for latching data of each bit of the display data of n bits. The multiplexer includes first to n-th multiplexer output terminals. In a test mode for testing the display data, each of the first to the m-th holding circuits serially outputs the display data of n bits that is held in each of the holding circuits as first to m-th serial output data from the output from the n-th latch circuit that is held in each of the holding circuits. Further, the multiplexer outputs the first to the m-th serial output data in a time-sharing way from the n-th multiplexer output terminal. Moreover, the first to the m-th serial output data is inputted into each of the first to the n-th D/A converting input terminals in a time-sharing way via the n-th multiplexer output terminal. The D/A converter carries out D/A conversion every time the data of each bit of the first to the m-th serial output data inputted into the first to the n-th D/A converting input terminals is inputted and outputs the gray scale voltage.

According to the first aspect of the invention, the display driver, in the test mode for testing the display data, can output display data for a plurality of pixels from a drive voltage output terminal in a time-sharing way as digital serial data. Thus, a matching analysis can be carried out between digital data when it is carried with a test pattern in the test mode, making it possible to enhance test accuracy and shorten test time.

In a display driver according to the first aspect of the invention, it is also acceptable that each of the first to the m-th holding circuits outputs the display data that is latched in the first to the n-th latch circuits to the multiplexer based on the scan enable signal, wherein the data of the first to the n-th bit that is held in the first to the n-th latch circuits is outputted to the multiplexer via each of the different output lines in the case where the scan enable signal is set non-active and the data of the first to the n-th bit is outputted from the output terminal of the n-th latch circuit to the multiplexer as serial output data in the case where the scan enable signal is set active.

Thus, the multiplexer can output the serial output data from each of the first to the m-th holding circuits in a time-sharing way in the case where the scan enable signal is set active.

In a display driver according to the first aspect of the invention, it is also acceptable that each of the first to the m-th holding circuits further includes first to (n−1)-th scan switch circuits, wherein the k-th (k is an integer greater than or equal to 1) scan switch circuit among the first to the (n−1)-th scan switch circuits, receiving the output from the k-th latch circuit among the first to the n-th latch circuits and the data of the (k+1)-th bit among the display data, outputs the output from the k-th latch circuit to the (k+1)-th latch circuit in the case where the scan enable signal is set active and outputs the output of the (k+1)-th bit to the (k+1)-th latch circuit in the case where the scan enable signal is set non-active.

Thus, each of the first to the m-th holding circuits can output the data that is latched in the first to the n-th latch circuits in each of the first to the m-th holding circuits from the output from the n-th latch circuit as serial output data in the case where the scan enable signal is set active.

A second aspect of the invention is to provide a display driver that includes first to m-th holding circuits (m is an integer greater than or equal to 2) each of which holds and outputs display data of n bits (n is an integer greater than or equal to 2) for at least one pixel, a multiplexer that receives display data for a plurality of pixels that is outputted from the first to the m-th holding circuits and outputs the display data for a plurality of pixels in a time-sharing way in the normal operation mode, and a D/A converter that, having first to n-th D/A converting input terminals, carries out D/A conversion based on data of n bits that is inputted via the first into the n-th D/A converting input terminals and outputs the output as a gray scale voltage. Here, each of the first to the m-th holding circuits includes first to n-th latch circuits for latching data of each bit of the display data of n bits. The multiplexer includes first to n-th multiplexer output terminals. In the test mode for testing the display data, each of the first to the m-th holding circuits serially outputs the display data of n bits that is held in each of the holding circuits as first to m-th serial output data from the output from the n-th latch circuit that is held in each of the holding circuits, with the first to the m-th serial output data being sequentially outputted from the output from the n-th latch circuit of the n-th multiplexer output terminal. Further, the multiplexer outputs the first to the m-th serial output data to the n-th multiplexer output terminal, with the first to the m-th serial output data being sequentially inputted via the n-th multiplexer output terminal into each of the first to the n-th D/A converting input terminals. The D/A converter carries out D/A conversion every time the data of each bit of the first to the m-th serial output data inputted into the first to the n-th D/A converting input terminals is inputted and outputs the gray scale voltage.

According to the second aspect of the invention, the display driver, in the test mode for testing the display data, can sequentially output display data for a plurality of pixels as digital serial data from a drive voltage output terminal. Thus, a matching analysis can be carried out between digital data when it is carried with a test pattern in the test mode, making it possible to enhance test accuracy and shorten test time.

In a display driver according to the second aspect of the invention, it is also acceptable that the multiplexer does not output the data that is inputted from the output from the first to the (m−1)-th holding circuits among the first to the m-th holding circuits to the first to the n-th multiplexer output terminals in the test mode.

Thus, the output from the first to the n-th latch circuits in the m-th holding circuit can be outputted to the first to the n-th multiplexer output terminals in the test mode.

In a display driver according to the second aspect of the invention, it is also acceptable that at least each of the second to the m-th holding circuits among the first to the m-th holding circuits includes a serial data input terminal to which the output from the n-th latch circuit of the last stage latch circuit is connected in the test mode, wherein each of the first to the m-th holding circuits outputs the display data that is latched in the first to the n-th latch circuits in each of the first to the m-th holding circuits to the multiplexer based on the scan enable signal, and, in the test mode, the scan enable signal is set active and each of the first to the m-th holding circuits outputs the display data of n bits as serial output data from the output terminal of the n-th latch circuit while the serial output data that is outputted from the output terminal of the n-th latch circuit of the last stage latch circuit is inputted into the serial data input terminal of the second to the m-th holding circuits and the first to the m-th serial output data is sequentially outputted to the multiplexer from the output terminal of the n-th latch circuit of the m-th holding circuit.

According to the second aspect of the invention, the m-th holding circuit among the first to the m-th holding circuits can sequentially output the first to the m-th serial output data from the output terminal of the n-th latch circuit of the m-th holding circuit in the test mode. Thus, the display data for each of the pixels that are held in the first to the m-th holding circuits is outputted from the drive voltage output terminal as digital serial data. Specifically, a highly precise test can be carried out because the digital display data can be detected from the drive voltage output terminal in the test mode.

Further, in a display driver according to the second aspect of the invention, it is also acceptable that each of the first to the m-th holding circuits further includes first to (n−1)-th scan switch circuits and a serial output data switch circuit, wherein the k-th (k is an integer greater than or equal to 1) scan switch circuit among the first to the (n−1)-th scan switch circuits, receiving the output from the k-th latch circuit among the first to the n-th latch circuits and the data of the (k+1)-th bit among the display data, outputs the output from the k-th latch circuit to the (k+1)-th latch circuit in the case where the scan enable signal is set active and outputs the data of the (k+1)-th bit to the (k+1)-th latch circuit in the case where the scan enable signal is set non-active. The serial output data switch circuit included in the l-th (l is an integer greater than or equal to 2) holding circuit among the first to the m-th holding circuits, receiving the output from the n-th latch circuit of the (l−1)-th holding circuit and the data of the first bit among the display data, outputs the output from the n-th latch circuit of the (l−1)-th holding circuit to the second latch circuit in the case where the scan enable signal is set active and outputs the data of the first bit of the display data to the second latch circuit in the case where the scan enable signal is set non-active.

Thus, in the first to the m-th holding circuits, whether or not the data of each bit of the display data that is held in each of the holding circuits is outputted from the output terminal of the n-th latch circuit of the m-th holding circuit can be switched.

Further, a display driver according to the second aspect of the invention can also include a mode selector that outputs the inputted data while switching the output route between the normal operation mode and the test mode. Here, the mode selector includes first to n-th mode selector input terminals that are connected to the first to the n-th multiplexer output terminal of the multiplexer and first to n-th mode selector output terminals for outputting the display data inputted from the multiplexer. In the test mode, the mode selector, receiving the digital output enable signal that is set active, electrically connects the n-th mode selector input terminal, among the first to the n-th mode selector input terminals, that receives the serial output data that is outputted from the n-th multiplexer output terminal of the multiplexer to each of the first to the n-th mode selector output terminals, and outputs the serial output data from the n-th latch circuit to the first to the n-th mode selector output terminals.

According to the second aspect of the invention, because the display data that is serially outputted from the multiplexer is inputted into each of the input terminals of the D/A converter in similar fashion by the mode selector in the test mode for testing the display data, the voltage according to each bit of the display data can be serially outputted from the drive voltage output terminal. Because the testing of the serially outputted voltage allows the reading of the data of each bit of the display data, a matching analysis can be carried out between digital data when it is carried with a test pattern in the test mode, making it possible to enhance test accuracy and shorten test time.

Further, in a display driver according to the second aspect of the invention, it is also acceptable that the mode selector includes first to (n−1)-th mode selector switch circuits, wherein the k-th (k is an integer greater than or equal to 1) mode selector switch circuit among the first to the (n−1)-th mode selector switch circuits, receiving the output from the k-th multiplexer output terminal that is connected to the k-th mode selector input terminal and the output from the n-th multiplexer output terminal that is connected to the n-th mode selector input terminal, outputs the output from the n-th multiplexer output terminal to the k-th mode selector output terminal in the case where the digital output enable signal is set active and outputs the output form the k-th multiplexer output terminal to the k-th mode selector output terminal in the case where the digital output enable signal is set non-active.

A third aspect of the invention is to provide a display driver that includes first to m-th holding circuits each of which holds and outputs display data for at least one pixel, a multiplexer that receives display data for a plurality of pixels that is outputted from the first to the m-th holding circuits and outputs the display data for a plurality of pixels in a time-sharing way in the normal operation mode, a D/A converter that carries out D/A conversion for the display data that is outputted from the multiplexer and outputs the output as a gray scale voltage, and an output selector in which the gray scale voltage based on the output from the D/A converter is inputted into a first input terminal and which outputs a drive voltage to the drive voltage output terminal. Here, each of the first to the m-th holding circuits includes first to n-th (n is an integer greater than or equal to 2) latch circuits for latching data of each bit of the display data for one pixel. In the normal operation mode, the multiplexer outputs the display data for a plurality of pixels in a time-sharing way per pixel and outputs the data of each bit of the display data for each pixel through different wirings. The D/A converter outputs the gray scale voltage based on the display data for one pixel that is outputted from the multiplexer. The output selector outputs the drive voltage from the drive voltage output terminal based on the gray scale voltage that is inputted into the first input terminal. In the test mode for testing the display data, each of the first to the m-th holding circuits serially outputs the data latched in the first to the n-th latch circuits from the output from the n-th latch circuit as serial output data while the serial output data that is outputted from each of the first to the m-th holding circuits is inputted into the second input terminal of the output selector via the multiplexer and the output selector outputs voltage based on the data of each bit of the serial output data that is inputted into the second input terminal to the drive voltage output terminal.

According to the third aspect of the invention, the display driver can output the display data for a plurality of pixels as digital serial data from the drive voltage output terminal in the test mode for testing the display data. Thus, a matching analysis can be carried out between digital data when it is carried with a test pattern in the test mode, making it possible to enhance test accuracy and shorten test time. Further, it makes it possible to prevent the drive voltage from being outputted from the drive voltage output terminal in the normal operation mode.

Further, in a display driver according to the third aspect of the invention, it is also acceptable that the multiplexer outputs, in a time-sharing way, the serial output data for each pixel that is outputted from each of the first to the m-th holding circuits per predetermined number of pixels in the test mode.

Thus, the data of each bit of the display data for a plurality of pixels can be outputted in a time-sharing way in the test mode, making it possible to obtain the display data for a plurality of pixels from the drive voltage output terminal as digital data of plural bits, which means that a highly precise test can be carried out in a short period of time.

Further, in a display driver according to the third aspect of the invention, it is also acceptable that each of the first to the m-th holding circuits outputs the display data that is latched in the first to the n-th latch circuits to the multiplexer based on the scan enable signal, outputting the data of the first to the n-th bit that is held in the first to the n-th latch circuits to the multiplexer via different output lines in the case where the scan enable signal is set non-active and outputting the data of the first to the n-th bit from the output terminal of the n-th latch circuit to the multiplexer as serial output data in the case where the scan enable signal is set active.

Further, in a display driver according to the third aspect of the invention, it is also acceptable that the multiplexer includes first to n-th multiplexer output terminals for outputting the display data, wherein in the test mode the first to the m-th serial output data that is outputted as serial output data from each of the first to the m-th holding circuits is sequentially outputted from the n-th latch circuit of the m-th holding circuit while at least the first to the m-th serial output data that is sequentially outputted from the n-th latch circuit of the m-th holding circuit, among the data outputted from the m-th holding circuit, is outputted to the n-th multiplexer output terminal.

Further, in a display driver according to the third aspect of the invention, it is also acceptable that at least each of the second to the m-th holding circuits among the first to the m-th holding circuits includes a serial data input terminal to which the output from the n-th latch circuit of the last stage holding circuit is connected in the test mode, wherein each of the first to the m-th holding circuits outputs the display data that is latched in the first to the n-th latch circuits to the multiplexer based on the scan enable signal. Here, each of the first to the m-th holding circuits outputs the first to the n-th bit data that is held in the first to the n-th latch circuits to the multiplexer via different output lines in the normal operation mode, when the scan enable signal is set non-active, while in the test mode, when the scan enable signal is set active, each of the first to the m-th holding circuits outputs the data of the first to the n-th bit from the output terminal of the n-th latch circuit as serial output data, the serial output data that is outputted from the output terminal of the n-th latch circuit of the last stage holding circuit is inputted into the serial data input terminal of the second to the m-th holding circuits, and the first to the m-th serial output data is sequentially outputted to the multiplexer from the output terminal of the n-th latch circuit of the m-th holding circuit.

Further, in a display driver according to the third aspect of the invention, it is also acceptable that a digital signal output line is placed between the output selector and the multiplexer, and each of the first to the n-th latch circuits of the first to the m-th holding circuits stores the data of the first to the n-th bit of the display data, and the output from the multiplexer is inputted into the second input terminal of the output selector via the digital signal output line. Here, the scan enable signal that is inputted into the first to the m-th holding circuits is set active in the test mode and each of the data of the first to the n-th bit of each of the first to the m-th holding circuits is outputted as the serial output data from the output terminal of the n-th latch circuit of each of the first to the m-th holding circuits, the serial output data that is outputted from each of the first to the m-th holding circuits is inputted into the second input terminal of the output selector via the multiplexer and the digital signal output line, and the output selector outputs the voltage from the drive voltage output terminal based on the serial output data that is inputted into the second input terminal.

According to the third aspect of the invention, the data that is latched in the first to the n-th latch circuits of the first to the m-th holding circuits can be serially outputted to the second input terminal of the output selector in the test mode. Thus, the display data can be serially outputted from the drive voltage output terminal in the test mode.

### BRIEF DESCRIPTION OF THE DRAWINGS

The invention will be described with reference to the accompanying drawings, wherein like numbers reference like elements.

FIG. 1 is a diagram showing a display driver according to the first embodiment.

FIG. 2 is a configuration example of a display driver according to the first embodiment.

FIG. 3 is a configuration example of a multiplexer according to the first and the second embodiments.

FIG. 4 is a configuration example of a mode selector according to the first and the second embodiments.

FIG. 5 is a timing chart for explaining the operation in the test mode of a display driver according to the first embodiment.

FIG. 6 is a timing chart for explaining the operation in the normal operation mode of a display driver according to the first embodiment.

FIG. 7 is a flowchart showing the test flow of a display driver according to the first and the second embodiments and a modified example.

FIG. 8 is a diagram showing a display driver according to the second embodiment.

FIG. 9 is a configuration example of a holding circuit of a display driver according to the second embodiment.

FIG. 10 is a timing chart for explaining the operation in the test mode of a display driver according to the second embodiment.

FIG. 11 is a configuration example of a comparative example of a display driver according to the first and the second embodiments.

FIG. 12 is a flowchart showing the test flow of a display driver in the comparative example.

FIG. 13 is a modified example of a display driver according to the first embodiment.

FIG. 14 is a modified example of a display driver according to the second embodiment.

### DESCRIPTION OF EXEMPLARY EMBODIMENTS

A preferred embodiment of the invention will now be described in detail with reference to the drawings. The embodiment to be described below does not unreasonably limit the scope of the invention that is claimed. The configurations to be described below are not necessarily always constituent requirements for the invention.

### 1. First Embodiment

1.1. Display Driver

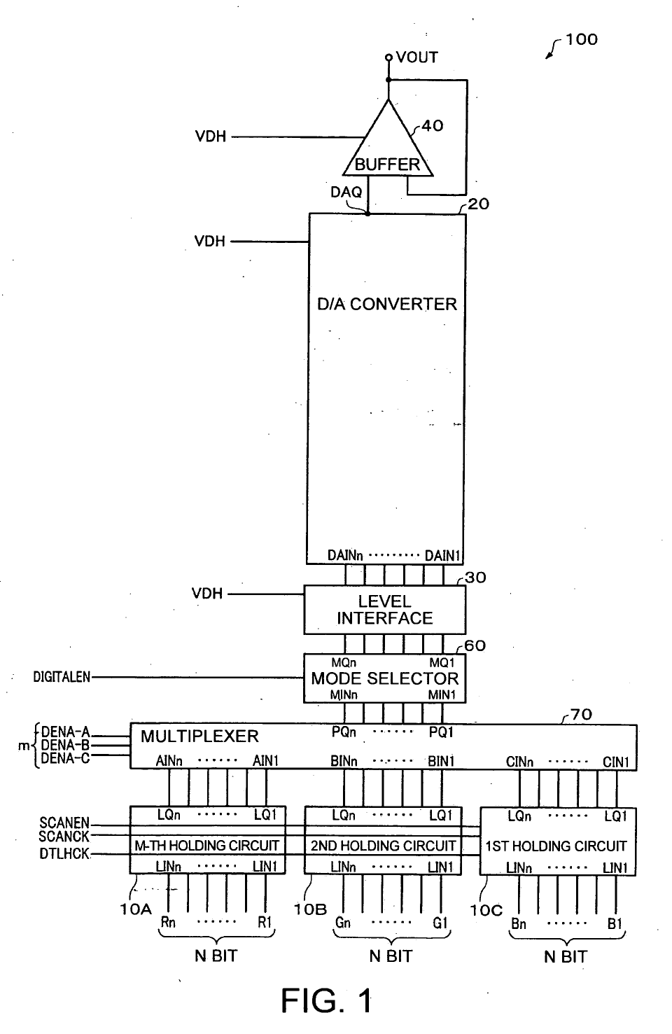

FIG. 1 is a diagram showing a display driver 100 according to the first embodiment. The display driver 100 includes holding circuits 10A to 10C (in general, the first to the m-th holding circuits) each of which respectively stores display data for one pixel, for example. The display driver 100 also includes a D/A converter 20 for D/A converting the display data, a multiplexer 70 for receiving the output from the holding circuits 10A to 10C, and a level interface 30 for adjusting the output level of the multiplexer 70. The display driver 100 further includes a buffer circuit 40 for outputting a drive voltage in response to the output from the D/A converter 20 and a drive voltage output terminal VOUT for outputting the drive voltage. The display driver 100 does not necessarily need to include all of the above-mentioned constituent elements. A configuration without the level interface 30 or the buffer circuit 40, for example, is also acceptable.

The display driver 100 in FIG. 1 shows a configuration example in which multiplex driving is applied for three pixels, which are the R pixel, G pixel and B pixel. Here, the display data for the R pixel is held in the holding circuit 10A, the display data for the G pixel is held in the holding circuit 10B, and the display data for the B pixel is held in the holding circuit 10C, although it is not limited to such. For example, the display driver 100 can include a plurality of holding circuits 10, wherein multiplex driving may be performed for a plurality of pixels, such as 6 pixels, 9 pixels, or the like.

The D/A converter 20 carries out D/A conversion based on the data of n bits that is inputted via each of the input terminals DAIN1 to DAINn and outputs a gray scale voltage corresponding to the data of n bits to the output terminal DAQ of the D/A converter 20.

Each of the holding circuits 10A to 10C includes a plurality of input terminals LIN1 to LINn and a plurality of output terminals LQ1 to LQn, wherein display data for one pixel is inputted into the plural input terminals LIN1 to LINn. Specifically, the data of each bit of the display data of n bits for one pixel is inputted into each of the input terminals LIN1 to LINn of the holding circuits 10A to 10C. For example, the data R1 of the first bit of the display data for R pixel is inputted into the input terminal LIN1 of the holding circuit 10A, the data R2 of the second bit of the display data for R pixel is inputted into the input terminal LIN2, and data Rn of the n-th bit of the display data is inputted into the input terminal LINn.

In the same way, the data G1 to Gn of each bit of the display data for G pixel is inputted into each of the input terminals LIN1 to LINn of the holding circuit 10B, and data B1 to Bn of each bit of the display data for B pixel is inputted into the input terminals LIN1 to LINn of the holding circuit 10C.

In the case where the scan enable signal SCANEN is set non-active, the holding circuits 10A to 10C, based on a clock DTLHCK, hold the display data of n bits inputted into each of the input terminals LIN1 to LINn and output the data of each bit of the display data of n bits from each of the output terminals LQ1 to LQn.

Meanwhile, in the case where the scan enable signal SCANEN is set active, the holding circuits 10A to 10C serially output the data of each bit of the display data of n bits, for example, from the output terminal LQn based on a scan clock SCANCK. In this case, serial output means outputting, for example, the data of the n-th bit from the output terminal LQn, then outputting the data of the (n−1)-th bit from the output terminal LQn, and then continuing to output the data sequentially until the data of the first bit is outputted. A series of data that is outputted through such serial output, which is data of from the n-th bit to the first bit, is referred to as serial output data.

For example, the scan enable signal SCANEN is set active for a predetermined period in the test mode and the first serial output data is outputted to the multiplexer 70 from the output terminal LQn of the holding circuit 10A. In the same way, the second serial output data is outputted to the multiplexer 70 from the holding circuit 10B and the third serial output data (in general, the m-th serial output data) is outputted to the multiplexer 70 from the holding circuit 10C.

The multiplexer 70 includes a plurality of input terminals AIN1 to AINn, BIN1 to BINn and CIN1 to CINn. The data R1 to Rn of each bit of the display data for R pixel, for example, is inputted into the input terminals AIN1 to AINn via the output terminals LQ1 to LQn of the holding circuit 10A (in general, the m-th holding circuit). In the same way, the data G1 to Gn of each bit of the display data for G pixel is inputted into the input terminals BIN1 to BINn from the holding circuit 10B, and the data B1 to Bn of each bit of the display data for B pixel is inputted into the input terminals CIN1 to CINn from the holding circuit 10C.

The multiplexer 70 also includes first to n-th multiplexer output terminals PQ1 to PQn and outputs the data that is outputted from each of the holding circuits 10A to 10C from each of the multiplexer output terminals PQ1 to PQn based on multiplexer control signals DENA-A, DENA-B and DENA-C. For example, in the normal operation mode, the display data for each pixel that is outputted from each of the holding circuits 10A to 10C is outputted from the first to the n-th multiplexer output terminals PQ1 to PQn, in a time-sharing way, per pixel. Specifically, the data R1 to Rn of each bit of the display data for R pixel inputted into the input terminals AIN1 to AINn, for example, is outputted from the multiplexer output terminals PQ1 to PQn. Then, after the data G1 to Gn of each bit of the display data for G pixel inputted into the input terminals BIN1 to BINn is outputted from the multiplexer output terminals PQ1 to PQn, the data B1 to Bn of each bit of the display data for B pixel inputted into the input terminals CIN1 to CINn is outputted from the multiplexer output terminals PQ1 to PQn.

Meanwhile, in the test mode, the first to the third serial output data (in general, the first to the m-th serial output data) is outputted from the output terminal LQn of each of the holding circuits 10A to 10C to the multiplexer 70. In this case, the multiplexer 70 outputs the first to the third serial output data from the multiplexer output terminal PQn in a time-sharing way per data, for example, of one bit (in general, per a predetermined number of bits).

Here, although a configuration example in which three holding circuits 10A to 10C are connected to the multiplexer 70 is shown in FIG. 1, it is not limited to such. It is acceptable that m number of multiplexer control signals may be used in the case where the first to the m-th holding circuits, or m number of holding circuits, are connected to the multiplexer 70.

A mode selector 60 includes a plurality of input terminals MIN1 to MINn (in general, the first to the n-th mode selector input terminals) and a plurality of output terminals MQ1 to MQn (in general, the first to the n-th mode selector output terminals). Each of the input terminals MIN1 to MINn is connected to the multiplexer output terminals PQ1 to PQn of the multiplexer 70. The mode selector 60 switches the connection between each of the input terminals MIN1 to MINn and each of the output terminals MQ1 to MQn based on the digital output enable signal DIGITALEN. Specifically, when the digital output enable signal DIGITALEN is set non-active, each of the input terminals MIN1 to MINn and each of the output terminals MQ1 to MQn is connected to each other, one to one. In this case, the input terminal MIN1, for example, is connected to the output terminal MQ1 and the input terminal MINn is connected to the output terminal MQn. Meanwhile, when the digital output enable signal DIGITALEN is set active, the input terminal MINn is connected to each of the output terminals MQ1 to MQn. For example, the input terminal MIN1 is connected to the output terminal MQn and the input terminal MINn is connected to the output terminal MQn.

In the test mode, the digital output enable signal DIGITALEN is set active while the scan enable signal SCANEN is set active for a predetermined period of time. In this case, the first to the third serial output data is serially outputted from the output terminal LQn of each of the holding circuits 10A to 10C. Then, the first to the third serial output data that is outputted serially is outputted to the mode selector 60 via the multiplexer 70 in a time-sharing way per one bit and is outputted from each of the output terminals MQ1 to MQn of the mode selector 60. Specifically, in this case, the same pulse is outputted from each of the output terminals MQ1 to MQn of the mode selector 60. Thus, the D/A converter 20 in the subsequent stage of the mode selector 60 can output digital data from a drive voltage output terminal VOUT by outputting voltage of high level or of low level in the test mode.

The level interface 30 receives the display data of n bits from the mode selector 60, adjusts it to the signal level suitable for the D/A converter 20 in the subsequent stage, and outputs it to the D/A converter 20. The level interface 30 receives, for example, the supply of voltage VDH regarding to the adjustment of the signal level, although it is not limited to such. The level interface 30 receives the display data of n bits via wirings that are different from each other from each of the output terminals MQ1 to MQn of the mode selector 60.

Specifically, the level interface 30 carries out level adjustment, for example, to the output from the output terminal MQ1 of the mode selector 60 and outputs it to the input terminal DAIN1 of the D/A converter 20. In the same way, the level interface 30 carries out level adjustment to the output from each of the output terminals MQ2 to MQn of the mode selector 60 and outputs it to each of the input terminals DAIN2 to DAINn of the D/A converter 20.

In the normal operation mode, for example, the scan enable signal SCANEN is set non-active and at the same time the digital output enable signal DIGITALEN is also set non-active. In this case, display data of n bits is outputted via each of the output terminals LQ1 to LQn from each of the holding circuits 10A to 10C and is outputted by the multiplexer 70 in a time-sharing way per pixel. Then, the signal corresponding to the data of each bit of the display data of n bits is inputted into each of the input terminals DAIN1 to DAINn of the D/A converter 20 via the mode selector 60 and the level interface 30. Specifically, when the data for R pixel, for example, is outputted, the signal corresponding to the data R1 of the first bit of the display data for R pixel is inputted into the input terminal DAIN1 and the signal corresponding to the data R2 of the second bit of the display data for the R pixel is inputted into the input terminal DAIN2. In the same way, the signal corresponding to the data Rn of the n-th bit of the display data for R pixel is inputted into the input terminal DAINn and it is the same for G pixel and B pixel. In general, the arrangement is the same for the data outputted from the m-th holding circuit.

In this way, in the normal operation mode, the D/A converter 20 outputs a gray scale voltage based on the display data of n bits that is outputted in a time-sharing way per pixel.

Further, in the test mode, the first to the third serial output data is serially outputted from the output terminal LQn of each of the holding circuits 10A to 10C and is outputted by the multiplexer 70 in a time-sharing way per one bit. Then, the data outputted in a time-sharing way is serially inputted into each of the input terminals DAIN1 to DAINn of the D/A converter 20 via the mode selector 60 and the level interface 30. Specifically, a common signal is inputted into each of the input terminals DAIN1 to DAINn of the D/A converter 20. In other words, because the same voltage of high level or of low level is inputted into each of the input terminals DAIN1 to DAINn in this case, the D/A converter 20 carries out D/A conversion based on this voltage and outputs two kinds of voltage, high level or low level, from the output terminal DAQ. Here, the voltage VDH is supplied with the D/A converter 20, although it is not limited to such.

In the embodiment, a configuration without the level interface 30 is also acceptable, wherein each of the output terminals MQ1 to MQn of the mode selector 60 is connected to each of the input terminals DAIN1 to DAINn of the D/A converter 20.

The buffer circuit 40 receives a gray scale voltage that is outputted from the output terminal DAQ of the D/A converter 20 and outputs it to the drive voltage output terminal VOUT.

Next, a configuration example of a display driver is shown in which display data for one pixel is composed, for example, of data of 6 bits (in general, n bits, wherein n is an integer) and the data of 6 bits, which is display data for one pixel for example, is stored in the holding circuit 10, although it is not limited to such.

1.2. Holding Circuit

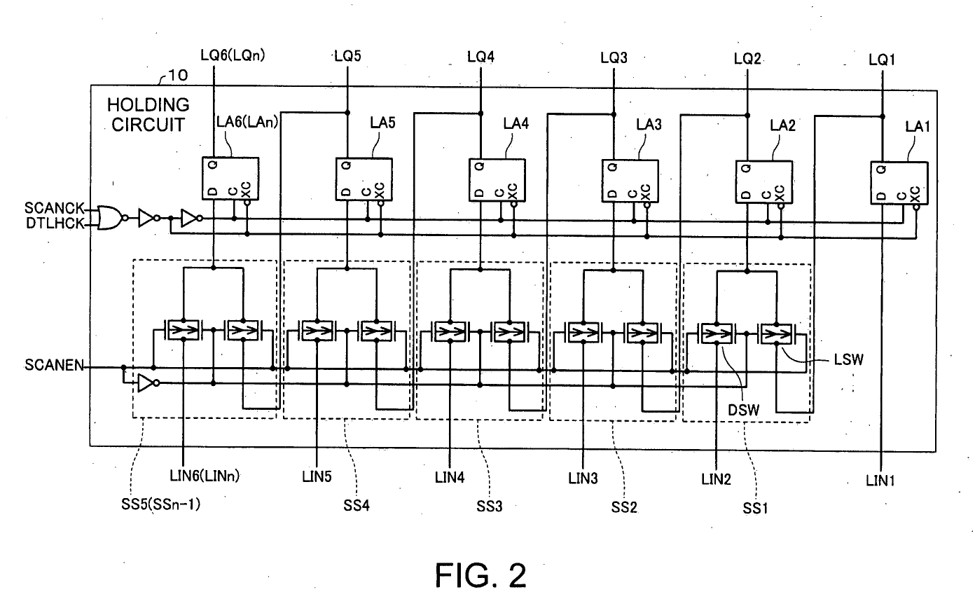

FIG. 2 is a diagram showing a configuration example of a holding circuit 10. Each of the holding circuits 10A to 10C in FIG. 1 is configured in the same way with the holding circuit 10 in FIG. 2. The holding circuit 10 in FIG. 2 includes first to n-th latch circuits LA1 to LAn and first to (n−1)-th scan switch circuits SS1 to SS(n−1). In FIG. 2, a configuration example in which display data of 6 bits is held is shown, wherein the holding circuit 10 includes 6 latch circuits LA1 to LA6 and 5 (subtract 1 from 6) scan switch circuits SS1 to SS5.

The output Q of each of the latch circuits LA1 to LA6 is connected to the output terminals LQ1 to LQ6 of the holding circuit 10. The input terminal LIN1 of the holding circuit 10 is connected to the input D of the latch circuit LA1. The output from each of the scan switch circuits SS1 to SS5 is connected to the input D of each of the remaining latch circuits LA2 to LA6. The output from the scan switch circuit SS1, for example, is connected to the input D of the latch circuit LA2 while the output from the scan switch circuit SS5, for example, is connected to the output D of the latch circuit LA6.

Clock based on the scan clock SCANCK or the clock DTLHCK is inputted into the clock input C of each of the latch circuits LA1 to LA6, while an inversion signal of the signal inputted into the clock input C is inputted into the inversion clock input XC of each of the latch circuits LA1 to LA6. Thus, each of the latch circuits LA1 to LA6 latches the data inputted into the input D of each of the latch circuits LA1 to LA6, outputs the data from the output Q of each of the latch circuits LA1 to LA6. Here, each of the latch circuits LA1 to LA6 is configured, for example, with a delay flip-flop (D-FF).

The output Q of the k-th latch circuit LAk (k is an integer smaller than or equal to n), among the latch circuits LA1 to LA6, is connected to the k-th scan switch circuit SSk among the scan switch circuits SS1 to SS(n−1). For example, the output Q of the third latch circuit LA3 is connected to the third scan switch circuit SS3. Further, each of the scan switch circuits SS1 to SS5 is connected to each of the input terminals LIN2 to LIN6 of the holding circuit 10. For example, the first scan switch circuit SS1 is connected to the input terminal LIN2 of the holding circuit 10. Here, the k-th latch circuit LAk and the k-th scan switch circuit SSk refer to the latch circuit LA1 and the scan switch circuit SS1 in the case where k equals 1, while refer to the latch circuit LA5 and the scan switch circuit SS5 in the case where k equals 5.

Here, each of the scan switch circuits SS1 to SS5 includes switches DSW and LSW that operate under on-off control based on the scan enable signal SCANEN. For example, the switch DSW of the k-th scan switch circuit SSk connects the output from the scan switch circuit SSk to the input terminal LINk of the holding circuit 10 based on the scan enable signal SCANEN. Thus, the input terminal LINk of the holding circuit 10 is connected to the input D of the (k+1)-th latch circuit LA(k+1).

Further, the switch LSW of the k-th scan switch circuit SSk, for example, connects the output Q of the k-th latch circuit LAk to the output from the scan switch circuit SSk based on the scan enable signal SCANEN. Thus, the output Q of the k-th latch circuit LAk is connected to the input D of the (k+1)-th latch circuit LA(k+1). Here, the input terminal LINk refers to the input terminal LIN1 in the case where k equals 1, while refers to the input terminal LIN5 in the case where k equals 5.

When the scan enable signal SCANEN is set active in the above-mentioned configuration, the switch LSW of the k-th scan switch circuit SSk is turned on while the switch DSW of the scan switch circuit SSk is turned off, connecting the output Q of the k-th latch circuit LAk to the input D of the (k+1)-th latch circuit LA(k+1). Meanwhile, when the scan enable signal SCANEN is set non-active, the switch DSW of the k-th scan switch circuit SSk is turned on while the switch LSW of the scan switch circuit SSk is turned off, connecting the input terminal LINk of the holding circuit 10 to the input D of the (k+1)-th latch circuit LA(k+1).

Specifically, the (k+1)-th latch circuit LA(k+1) latches the data of the output Q of the k-th latch circuit LAk in the case where the scan enable signal SCANEN is set active while latches the data inputted into the input terminal LINk of the holding circuit 10 in the case where the scan enable signal SCANEN is set non-active. Thus, in the case where the scan enable signal SCANEN is set active, the data of each bit of the display data of n bits inputted into the holding circuit 10 can be serially outputted from the output Q of the latch circuit LA6 (in general, the n-th latch circuit), which is the last stage latch circuit among the latch circuits LA1 to LA6.

Meanwhile, in the case where the scan enable signal SCANEN is set non-active, the holding circuit 10 holds the data supplied to the input terminals LIN1 to LIN6 with the latch circuits LA1 to LA6, and outputs the held data to the output terminals LQ1 to LQ6.

1.3. Multiplexer

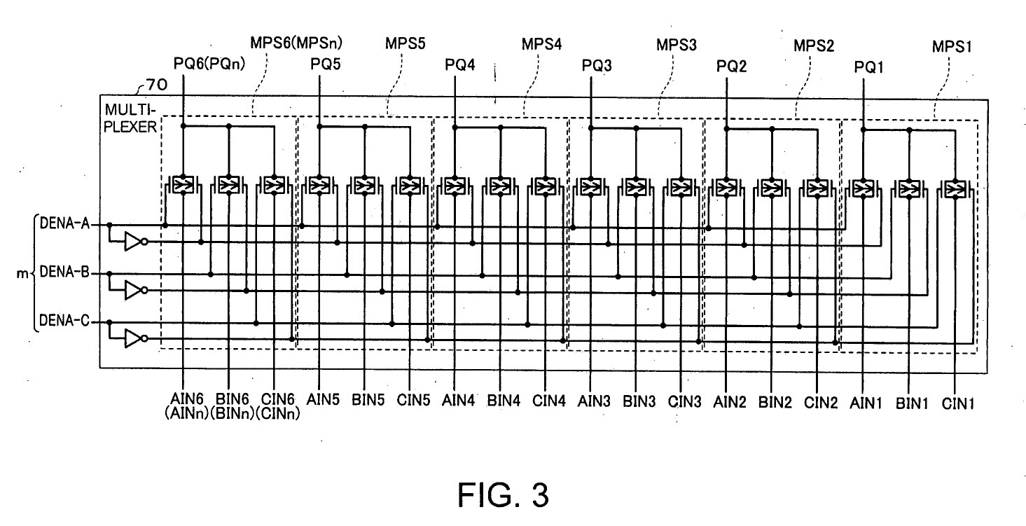

FIG. 3 is a diagram showing a configuration example of a multiplexer 70. The multiplexer 70 includes first to sixth multiplexer switch circuit MPS1 to MPS6 (in general, the first to the n-th multiplexer switch circuits MPS1 to MPSn) that are connected to first to n-th multiplexer output terminals PQ1 to PQn. Each of the multiplexer switch circuit MPS1 to MPSn switches the connection between the input terminals and the output terminals of the multiplexer 70 based on each of the multiplexer control signals DENA-A, DENA-B and DENA-C.

Specifically, the multiplexer switch circuit MPS1, for example, switches the connection between the input terminals AIN1, BIN1 and CIN1 and the multiplexer output terminal PQ1 based on each of the multiplexer control signals DENA-A, DENA-B and DENA-C. For example, when the multiplexer control signal DENA-A is set active, the multiplexer switch circuit MPS1 connects the input terminal AIN1 to the multiplexer output terminal PQ1. Similarly, the input terminal BIN1 is connected to the output terminal PQ1 in the case where the multiplexer control signal DENA-B is set active, and the input terminal CIN1 is connected to the output terminal PQ1 in the case where the control signal DENA-C is set active.

Also as for the remaining multiplexer switch circuits MPS2 to MPS6, just in the same way, each of the corresponding input terminals is connected to each of the output terminals PQ2 to PQ6 to which each of the multiplexer switch circuits MPS2 to MPS6 is connected based on each of the control signals DENA-A, DENA-B and DENA-C. For example, the sixth multiplexer switch circuit MPS6 (in general, the n-th multiplexer switch circuit MPSn) switches the connection between each of the input terminals AIN6, BIN6 and CIN6 and the multiplexer output terminal PQ6 based on each of the multiplexer control signals DENA-A, DENA-B and DENA-C.

With such a configuration, the multiplexer 70, in the case where the multiplexer control signal DENA-A is set active, connects each of the multiplexer output terminals PQ1 to PQn to each of the input terminals AIN1 to AINn. Thus, the data that is outputted from each of the output terminals LQ1 to LQn of the third holding circuit 10A (in general, the m-th holding circuit) in FIG. 1 is outputted from each of the multiplexer output terminals PQ1 to PQn of the multiplexer 70. Similarly, in the case where the multiplexer control signals DENA-B is set active, the output from the second holding circuit 10B is outputted from each of the multiplexer output terminals PQ1 to PQn, and, in the case where multiplexer control signals DENA-C is set active, the output from the first holding circuit 10C is outputted from each of the multiplexer output terminals PQ1 to PQn.

Here, in FIG. 1, three holding circuits 10A to 10C are shown as a configuration example of the embodiment. Thus, the multiplexer 70, for example, using the three multiplexer control signals DENA-A, DENA-B and DENA-C, can output the output from each of the holding circuits 10A to 10C in a time-sharing way from the multiplexer output terminals PQ1 to PQn. For example, in the case where the first to the m-th holding circuits are connected to the multiplexer 70, m kinds of multiplexer control signals can be used.

1.4. Mode Selector

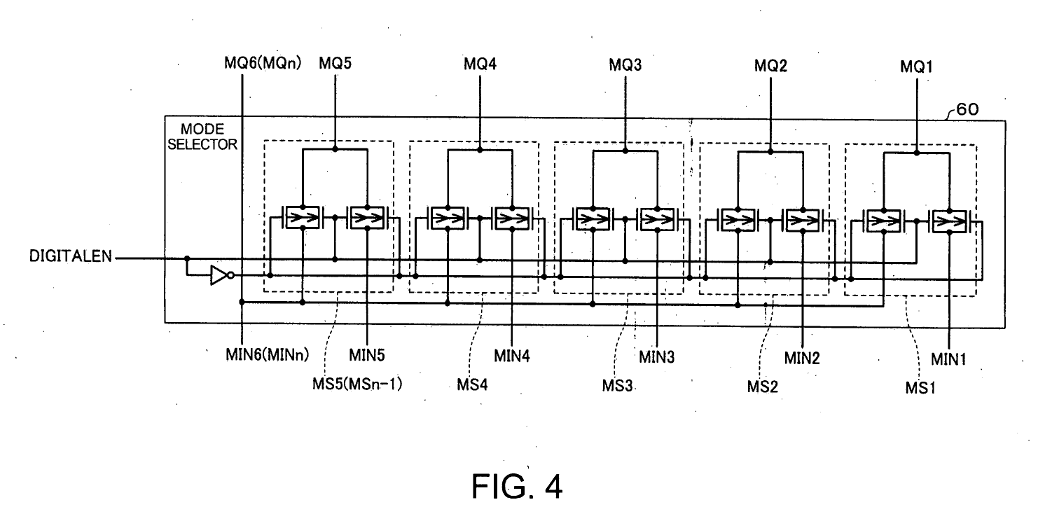

A configuration example of a mode selector 60 is shown in FIG. 4. The mode selector 60-includes first to (n−1)-th mode selector switch circuits MS1 to MS(n−1). The k-th mode selector switch circuit MSk, among the first to the (n−1)-th mode selector switch circuits MS1 to MS(n−1), connects either of the input terminal MINk or the input terminal MINn to the output terminal MQk of the mode selector 60 based on the digital output enable signal DIGITALEN.

For example, in the case where the digital output enable signal DIGITALEN is set active, the input terminal MINn of the mode selector 60 is connected to the output terminal MQk of the mode selector 60. Meanwhile, in the case where the digital output enable signal DIGITALEN is set non-active, the input terminal MINk is connected to the output terminal MQk.

Specifically, in the case where the digital output enable signal DIGITALEN is set active, the mode selector switch circuit MS1, for example, connects the input terminal MIN6 (MINn) to the output terminal MQ1, and the mode selector switch circuit MS5, for example, connects the input terminal MIN6 (MINn) to the output terminal MQ5.

Further, in the case where the digital output enable signal DIGITALEN is set non-active, the mode selector switch circuit MS1, for example, connects the input terminal MIN1 to the output terminal MQ1, and the mode selector switch circuit MS5, for example, connects the input terminal MIN5 to the output terminal MQ5.

Here, the input terminal MIN6 (MINn) is connected to the output terminal MQ6 (MQn) regardless of the digital output enable signal DIGITALEN.

In the above-mentioned configuration, the digital output enable signal DIGITALEN is set non-active in the normal operation mode. In this case, the output from each of the multiplexer output terminals PQ1 to PQn is outputted from each of the output terminals MQ1 to MQn of the mode selector 60.

Meanwhile, in the test mode, the digital output enable signal DIGITALEN is set active. In this case, the output from the multiplexer output terminal PQn, among the multiplexer output terminals PQ1 to PQn, is outputted from each of the output terminals MQ1 to MQn of the mode selector 60.

1.5. Operation

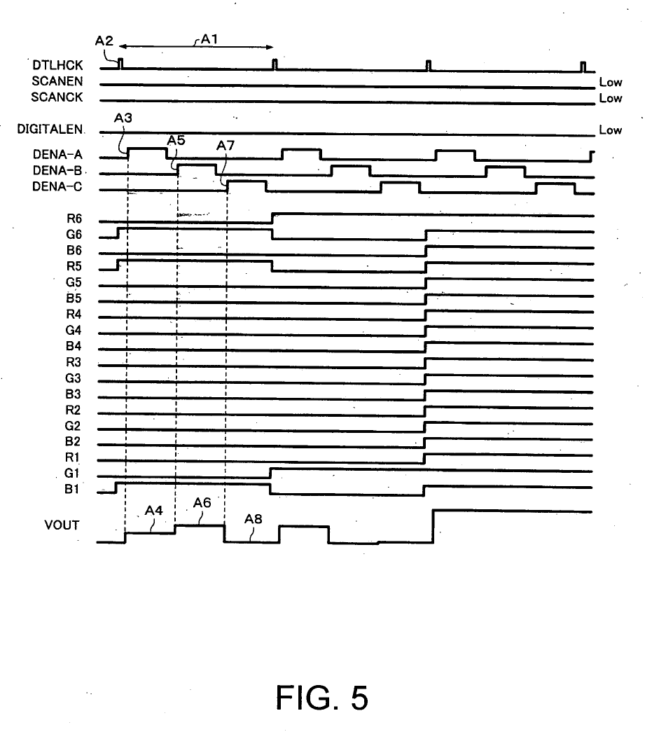

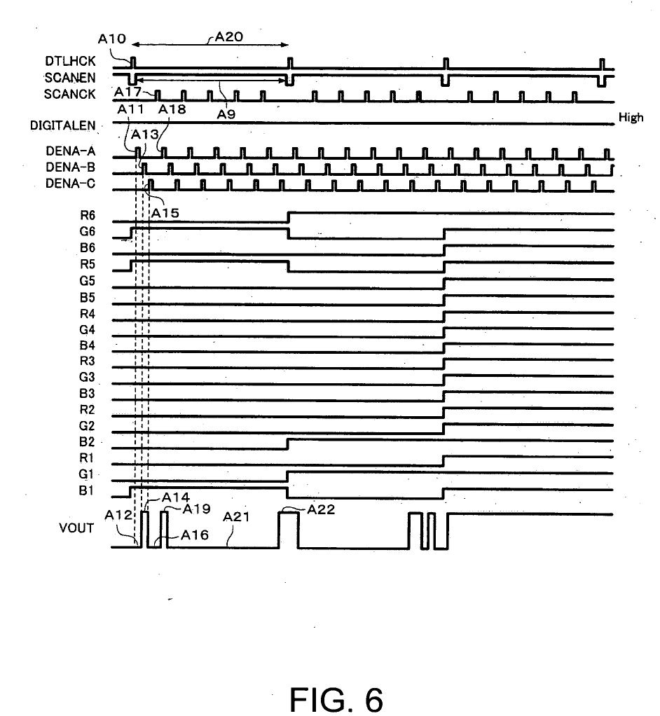

The operation of the display driver 100 of the embodiment will now be described using the timing charts in FIGS. 5 and 6. FIG. 5 is a timing chart showing the operation in the normal operation mode. In the normal operation mode, the scan enable signal SCANEN that is inputted into the holding circuits 10A to 10C is set non-active (for example, at low level). Meanwhile, the digital output enable signal DIGITALEN that is inputted into the mode selector 60 is set non-active (for example, at low level).

In the operation to be described below, the display data for R pixel is inputted into the holding circuit 10A, the display data for G pixel is inputted into the holding circuit 10B, and the display data for B pixel is inputted into the holding circuit 10C, although it is not limited to such.

In the normal operation mode, display data for a plurality of pixels is inputted into the D/A converter 20, based on the clock DTLHCK, in a time-sharing way per pixel. The D/A converter 20 converts the inputted display data per pixel and outputs it from the output terminal DAQ as a gray scale voltage. The voltage based on the gray scale voltage is outputted from the drive voltage output terminal OUT.

For example, in the period A1, the clock DTLHCK arises at the timing of A2 and the display data for each for R pixel, G pixel and B pixel is inputted into the D/A converter 20 in a time-sharing way based on the multiplexer control signals DENA-A, DENA-B and DENA-C. For example, when the multiplexer control signal DENA-A is set active, the voltage based on the display data for R pixel outputted from the multiplexer 70 is inputted. Specifically, when the multiplexer control signal DENA-A arises at the timing of A3, the data based on the output from the holding circuit 10A at this timing is inputted into the D/A converter 20. The display data R5 of the fifth bit that is outputted from the output terminal LQ5 of the holding circuit LQ5 at the timing of A3 is of high level, while the other data R1 to R4 and R6 are of low level. Because the D/A converter 20 carries out D/A conversion based on the data R1 to R6 of each bit at this timing, the drive voltage shown at A4 is outputted from the drive voltage output terminal VOUT.

Next, when the multiplexer control signal DENA-B arises at the timing of A5, the voltage based on the display data for G pixel outputted from the multiplexer 70 is inputted into the D/A converter 20. At this timing, the data G6 of the sixth bit outputted from the holding circuit 10B is of high level, while the other data G1 to G5 of the first to the fifth bit is of low level. The D/A converter 20 outputs a gray scale voltage from the output terminal DAQ based on the data G1 to G6 of each bit that is outputted from the holding circuit 10B at this timing. Thus, the drive voltage shown at A6 is outputted from the drive voltage output terminal VOUT.

Next, when the multiplexer control signal DENA-C arises at the timing of A7, the voltage based on the display data for B pixel outputted from the multiplexer 70 is inputted into the D/A converter 20. At this timing, the data B1 of the first bit outputted from the holding circuit 10C is of high level, while the data G1 to G5 of the second to the sixth bit is of low level. The D/A converter 20 outputs the gray scale voltage from the output terminal DAQ based on the data B1 to B6 of each bit outputted from the holding circuit 10C at this timing. Thus, the drive voltage shown at A8 is outputted from the drive voltage output terminal VOUT.

As described above, in the normal operation mode, the multiplexer 70 outputs the display data for a plurality of pixels in a time-sharing way per pixel. Thus, the display data for a plurality of pixels is outputted per pixel, and the drive voltage corresponding to the display data for each pixel is outputted from the drive voltage output terminal VOUT.

The operation in the test mode will now be described using FIG. 6. In the test mode for testing the display driver 100, the digital output enable signal DIGITALEN that is inputted into the mode selector 60 is set active. Thus, as described above, the data inputted into the input terminal MIN6 of the mode selector 60 in FIG. 4 is outputted from the output terminals MQ1 to MQn in a common way.

Further, the scan enable signal SCANEN inputted into the holding circuits 10A to 10C is set active in the period shown at A9, for example. Thus, the data of each bit is serially outputted from the output terminal LQ6 of each of the holding circuits 10A to 10C based on the scan clock SCANCK.

For example, when the clock DTLHCK arises at the timing of A10, the holding circuits 10A to 10C hold the inputted display data for each pixel. Then when the multiplexer control signal DENA-A arises at the timing of A11, the multiplexer 70 outputs the output from the holding circuit 10A to the mode selector 60. At this moment, the data R6 of the sixth bit for R pixel that is outputted from the output terminal LQ6 of the holding circuit 10A is inputted into the input terminal MIN6 of the mode selector 60. At this timing, the data R6 of the sixth bit is of low level according to FIG. 6. Specifically, a low level voltage is inputted into the input terminal MIN6 of the mode selector 60, and a low level voltage is inputted into the input terminals DAIN1 to DAIN6 of the D/A converter 20. Thus, the D/A converter 20 outputs a low level voltage from the output terminal DAQ as a gray scale voltage, and the drive voltage shown at A12 is outputted from the drive voltage output terminal VOUT.

Next, when the multiplexer control signal DENA-B arises at the timing of A13, the multiplexer 70 outputs the output from the holding circuit 10B to the mode selector 60. At this timing, the data R6 of the sixth bit for G pixel outputted from the output terminal LQ6 of the holding circuit 10B is inputted into the input terminal MIN6 of the mode selector 60. At this timing, the data G6 of the sixth bit is of high level according to FIG. 6. Specifically, a high level voltage is inputted into each of the input terminals DAIN1 to DAIN6 of the D/A converter 20 via the mode selector 60. Thus, the D/A converter 20 outputs the high level voltage from the output terminal DAQ as a gray scale voltage, and the drive voltage shown at A14 is outputted from the drive voltage output terminal VOUT.

Next, when the multiplexer control signal DENA-C arises at the timing of A15, the multiplexer 70 outputs the output from the holding circuit 10C to the mode selector 60. At this timing, the data B6 of the sixth bit for B pixel inputted into the input terminal MIN6 of the mode selector 60 is of low level according to FIG. 6. Specifically, a low level voltage is inputted into each of the input terminals DAIN1 to DAIN6 of the D/A converter 20 via the mode selector 60. Thus, the D/A converter 20 outputs the low level voltage from the output terminal DAQ as a gray scale voltage, and the drive voltage shown at A16 is outputted from the drive voltage output terminal VOUT.

In this way, the data R6, G6 and B6 of the sixth bit of the display data for each pixel is outputted from the drive voltage output terminal VOUT.

Next, the scan clock SCANCK arises at the timing of A17. Thus, the latch circuit LA6 of each of the holding circuits 10A to 10C latches the output from the latch circuit LA5. Specifically, the data of the fifth bit of the display data for each pixel is outputted from the output terminal LQ6 of each of the holding circuits 10A to 10C. Specifically, the data R5 of the fifth bit for R pixel is outputted from the output terminal LQ6 of the holding circuit 10A, the data G5 of the fifth bit for G pixel is outputted from the output terminal LQ6 of the holding circuit 10B and the data B5 of the fifth bit for B pixel is outputted from the output terminal LQ6 of the holding circuit 10C.

When the multiplexer control signal DENA-A arises at the timing of A18 after the scan clock SCANCK has arisen at the timing of A17, the multiplexer 70 outputs the data R5 of the fifth bit for R pixel outputted from the holding circuit 10A to the mode selector 60. At this timing, the data R5 of the fifth bit for R pixel inputted into the input terminal MIN6 of the mode selector 60 is of high level according to FIG. 6. Specifically, a high level voltage is inputted into each of the input terminals DAIN1 to DAIN6 of the D/A converter 20 via the mode selector 60. Thus, the D/A converter 20 outputs the high level voltage from the output terminal DAQ as a gray scale voltage, and the drive voltage shown at A19 is outputted from the drive voltage output terminal VOUT.

As mentioned above, after the data Rn, Gn and Bn of the n-th bit is outputted to the mode selector 60 in a time-sharing way via the multiplexer 70 from the holding circuits 10A to 10C, the multiplexer 70 receives the data R(n−1), G(n−1) and B(n−1) of the (n−1)-th bit from each of the holding circuits 10A to 10C based on the arising of the scan clock SCANCK. The multiplexer 70 outputs the inputted data to the mode selector 60 in a time-sharing way based on the multiplexer control signals DENA-A, DENA-B and DENA-C.

The display driver 100 repeats this operation until the multiplexer 70 outputs the data R1, G1 and B1 of the first bit for each pixel to the mode selector 60. Thus, the display data R1 to Rn, G1 to Gn and B1 to Bn for each pixel is outputted from the drive voltage output terminal VOUT. The order in which the data is outputted is, for example, R6, G6, B6, R5, G5, B5, R4, G4, B4 . . . R1, G1 and B1.

For example, in the period shown at A20, the data R5 of the fifth bit for R pixel, the data G6 of the sixth bit for G pixel and the data B1 of the first bit for B pixel is of high level, and the remaining data is of low level. At this timing, if high level is defined as “1” and low level is defined as “0”, the display data of 6 bits for R pixel can be described as (010000), the display data of 6 bits for G pixel can be described as (100000), and the display data of 6 bits for B pixel can be described as (000001).

In accordance with the above-mentioned order of data, the data outputted from the drive voltage output terminal VOUT in the test mode can be described as (010100000000000001). Specifically, A14 shows that the data R5 is of high level, A19 shows that the data G6 is of high level, and A22 shows that the data B1 is of high level. In this way, in the test mode, the value of the display data R1 to Rn, G1 to Gn and B1 to Bn for each pixel can be read out by detecting the pulse that is outputted from the drive voltage output terminal VOUT.

As described above, the display driver 100 according to the embodiment, in the test mode, can output the display data of 6 bits for each pixel stored on each of the holding circuits 10A to 10C from the drive voltage output terminal VOUT as digital serial output data.

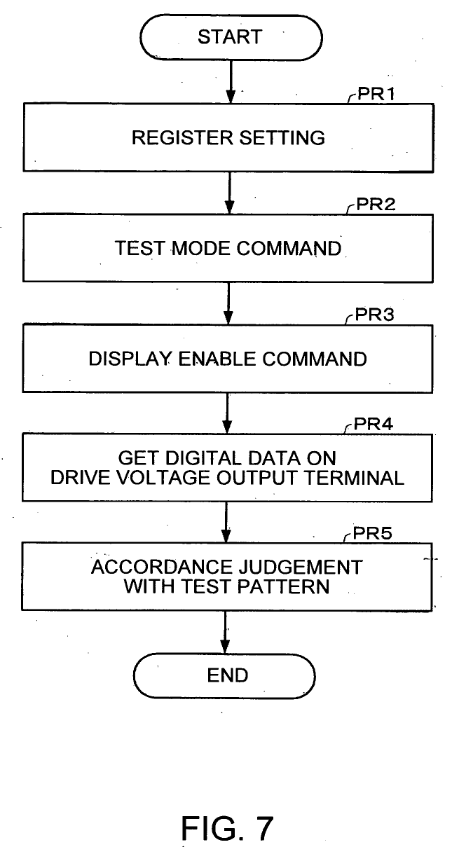

An example of a test flow of a display driver 100 according to the embodiment is shown in FIG. 7. In the process PR1, preferences for an internal resistor of the display driver 100 are set. Next in the process PR2, a command for setting test mode is sent out to the display driver 100. By this command, the digital output enable signal DIGITALEN that is set active is inputted into the mode selector 60 of the display driver 100. Before carrying out the test, a test pattern for the display data is written in advance to a display memory or the like where the display data is stored, although this writing out is not limited to the process PR2 and can be carried out also in other processes.

Next, in the process PR3, a display enable command is sent out to the display driver 100. By the display enable command, the display data for each pixel, for example, is outputted to the holding circuit 10 of the display driver 100 from the display memory where the display data is stored. Further, as shown in the timing chart in FIG. 6, as the clock DTLHCK, the scan clock SCANCK and the scan enable signal SCANEN are inputted into each of the holding circuits 10A to 10C, the digital data of the display data of 6 bits for each pixel is inputted into the D/A converter 20 via the multiplexer 70. Thus, the display data of 6 bits for each pixel is serially outputted from the drive voltage output terminal VOUT, for example, as data of 18 bits.

Next, in the process PR4, the display data of 6 bits for each pixel that is outputted from the drive voltage output terminal VOUT in the process PR3 is obtained as digital serial data.

Next, in the process PR5, a matching analysis is carried out, comparing the display data of 6 bits for each pixel that is obtained in the process PR4 and the test pattern for the display data that has been set in advance. By this matching analysis, various things such as whether the display driver 100 operates as designed and the like can be analyzed.

In this way, the display driver 100 according to the embodiment can carry out highly precise tests because the display driver 100 can be tested using digital display data. Here, the above mentioned test flow is just an example of tests, and does not limit the display driver 100 according to the embodiment.

### 2. Second Embodiment

2.1. Display Driver

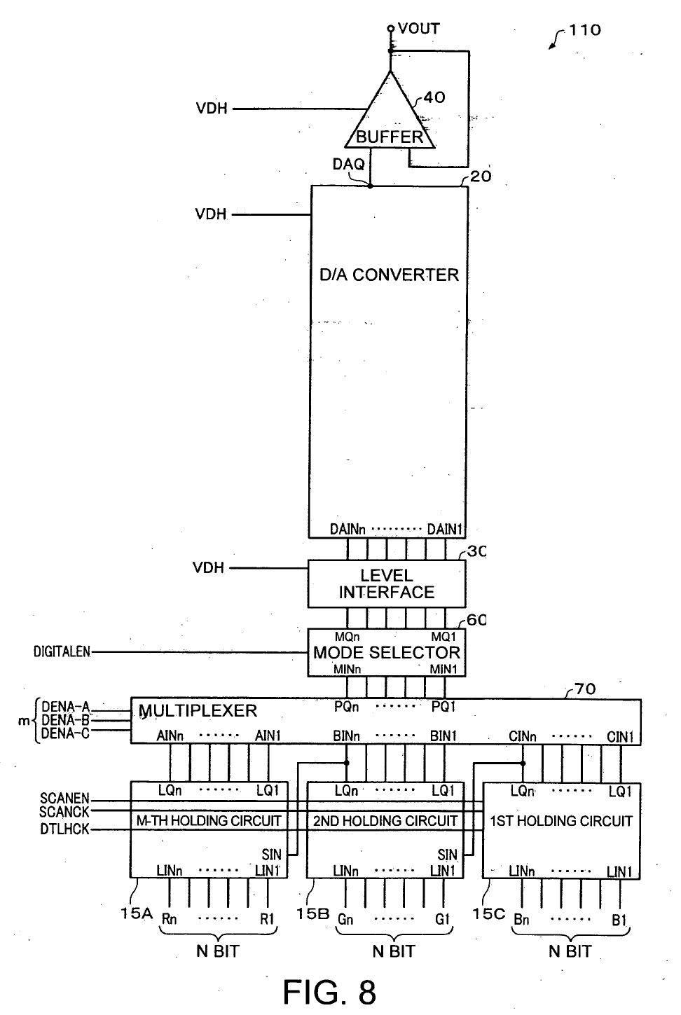

FIG. 8 is a diagram showing the display driver 110 according to the first embodiment. The display driver 110 includes holding circuits 15A to 15C (in general, the first to the m-th holding circuits) each of which holds display data for one pixel, for example, a D/A converter 20 for D/A converting the display data, a multiplexer 70 for receiving the output from the holding circuits 15A to 15C, a level interface 30 for adjusting the output level of the multiplexer 70, a buffer circuit 40 for receiving the output from the D/A converter 20 and outputs the drive voltage, and a drive voltage output terminal VOUT for outputting the drive voltage, although it is not limited to such. The display driver 110 does not necessarily include all of the above-mentioned constituent elements. A configuration without the level interface 30 or the buffer circuit 40, for example, is also acceptable.

Here, the explanation about the operation of the D/A converter 20, the level interface 30, the buffer circuit 40 and the mode selector 60 is not given because it has already been given in the first embodiment.

In the second embodiment, just like in the first embodiment, FIG. 8 shows a configuration example of a display driver 110 for multiplex driving three pixels, R pixel, G pixel and B pixel. The display data for R pixel is held in the holding circuit 15A, the display data for G pixel is held in the holding circuit 15B, and the display data for B pixel is held in the holding circuit 15C, although it is not limited to such. For example, a plurality of holding circuits 10 can be prepared for the display driver 110 for multiplex driving a plurality of pixels, such as 6 pixels, 9 pixels or the like.

Each of the holding circuits 15A to 15C includes, just like in the holding circuits 10A to 10C in FIG. 1, a plurality of input terminals LIN1 to LINn and a plurality of output terminals LQ1 to LQn, and display data for one pixel is inputted into the plurality of input terminals LIN1 to LINn.

Further, the holding circuits 15A and 15B (in general, the second to the m-th holding circuits) include a serial data input terminal SIN, and the output from the latch circuit LAn of the last stage holding circuit is inputted into the serial data input terminal SIN. Specifically, the output from the latch circuit LA6 of the holding circuit 15B, which is the last stage holding circuit of the holding circuit 15A, is inputted into the serial data input terminal SIN of the holding circuit 15A, and the output from the latch circuit LA6 of the holding circuit 15C, which is the last stage holding circuit of the holding circuit 15B, is inputted into the serial data input terminal SIN of the holding circuit 15B. Here, the last stage holding circuit of the m-th holding circuit refers to the (m−1)-th holding circuit. The serial data input terminal SIN can be placed also in the holding circuit 15C.

In the case where the scan enable signal SCANEN is set non-active, the holding circuits 15A to 15C outputs the data of each bit of the display data of n bits from each of the output terminals LQ1 to LQn based on the clock DTLHCK, just in the same way with the holding circuits 10A to 10C in FIG. 1.

Meanwhile, in the case where the scan enable signal SCANEN is set active, each of the holding circuits 15A to 15C serially outputs the data of each bit of the holding display data of n bits from the output terminal LQn based on the scan clock SCANCK, for example. In the test mode, for example, the scan enable signal SCANEN is set active for a determined period, and the first serial output data that is composed of the data Rn to R1 of the sixth to the first bit is outputted from the output terminal LQn of the holding circuit 15A. Similarly, the second serial output data that is composed of the data Gn to G1 of the sixth to the first bit is outputted from the holding circuit 15B, and the third serial output data (in general, the m-th serial output data) that is composed of the data Bn to B1 of the sixth to the first bit is outputted from the holding circuit 15C.

Further, into the serial data input terminal SIN of the holding circuit 15A, the second serial output data that is outputted from the last stage holding circuit 15B is inputted, and into the serial data input terminal SIN of the holding circuit 15B, the third serial output data of the last stage holding circuit 15C is inputted. Thus, the first to the third serial output data is sequentially outputted from the output terminal LQn of the holding circuit 15A.

The configuration of the multiplexer 70 can be the same with that in the first embodiment. Although the multiplexer 70, in the normal operation mode in the embodiment, operates in the same way as in the normal operation mode in the first embodiment, the operation in the test mode is different from that in the first embodiment. In the test mode in the embodiment, the first to the third serial output data (in general, the first to the m-th serial output data) that is sequentially outputted from the output terminal LQn of each of the holding circuits 15A to 15C is inputted into the input terminal AINn of the multiplexer 70. In this case, the multiplexer 70 sequentially outputs the first to the third serial output data from the multiplexer output terminal PQn.

Although a configuration example in which three holding circuits 10A to 10C are connected to a multiplexer 70 is shown in FIG. 8, it is not limited to such. In the case where the first to the m-th holding circuits, or m number of holding circuits, are connected to the multiplexer 70, m number of multiplexer control signals can be used.

In the test mode, the first to the third serial output data is sequentially outputted to the mode selector 60 from the multiplexer output terminal PQn, and then is outputted from the output terminals MQ1 to MQn of the mode selector 60. Specifically, in this case, the same pulse is outputted from each of the output terminals MQ1 to MQn of the mode selector 60. Thus, the subsequent stage D/A converter 20 of the mode selector 60 can output digital data from the drive voltage output terminal VOUT by outputting a high level voltage or a low level voltage in the test mode.

In the embodiment, a configuration in which the level interface 30 is not included and each of the output terminals MQ1 to MQn of the mode selector 60 is connected to the input terminals DAIN1 to DAINn of the D/A converter 20 is also acceptable.

Now, a configuration example of a display driver in which the display data for one pixel is, for example, composed of data of 6 bits (in general, n bits, wherein n is an integer) and the data of 6 bits, which is the display data for one pixel, for example, is stored in the holding circuits 15A to 15C, although it is not limited to such.

2.2. Holding Circuit

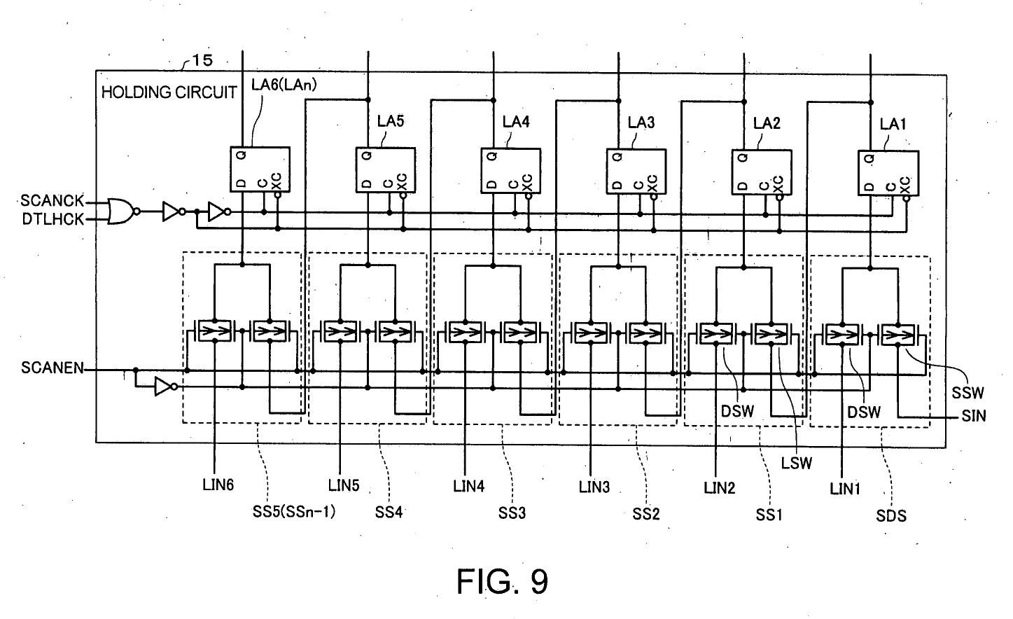

FIG. 9 is a diagram showing a configuration example of the holding circuit 15. The holding circuits 15A and 15B in FIG. 8 are configured in the same way with the holding circuit 15 in FIG. 9, and the holding circuit 15C in FIG. 8 is configured in the same way with the holding circuit 10 in FIG. 2, although it is not limited to such. For example, the holding circuit 15C in FIG. 8 can be configured in the same way with the holding circuit 15 in FIG. 9.

The holding circuit 15 in FIG. 9 is configured with a serial output data switch circuit SDS placed in the holding circuit 10 in FIG. 2. Its basic operation is the same with the holding circuit 10 in FIG. 2 except in that the output from the last stage holding circuit is inputted into the latch circuit LA1 of the holding circuit 15. Explanation on each of the scan switch circuits SS1 to SS5 is not given. In FIG. 9, a configuration example in which the display data of 6 bits is held is shown, and the holding circuit 15 includes 6 latch circuits LA1 to LA6, 5 (subtracted 1 from 6) scan switch circuits SS1 to SS5, and a serial output data switch circuit SDS.

The output from the serial output data switch circuit SDS is connected to the input D of the latch circuit LA1. The serial output data switch circuit SDS includes switches DSW and LSW that operate under on-off control based on the scan enable signal SCANEN. For example, the switch DSW of the serial output data switch circuit SDS connects, based on the scan enable signal SCANEN, the input terminal LIN1 of the holding circuit 15 and the output from the serial output data switch circuit SDS. Thus, the input terminal LIN1 of the holding circuit 15 is connected to the input D of the first latch circuit LA1.

Further, the switch LSW of the serial output data switch circuit SDS, for example, connects the serial data input terminal SIN and the output from the serial output data switch circuit SDS based on the scan enable signal SCANEN. Thus, the output terminal LQ6 of the last stage holding circuit 15 is connected to the input D of the first latch circuit LA1, and the output data from the latch circuit LA6 of the last stage holding circuit 15 is inputted into the input D of the latch circuit LA1 of the holding circuit 15 in FIG. 9.

In the above-mentioned configuration, when the scan enable signal SCANEN is set active, the switch SSW of the serial output data switch circuit SDS is turned on, connecting in series the latch circuits LA1 to LA6 of the last stage holding circuit 15 and the latch circuits LA1 to LA6 of the holding circuit 15 in FIG. 9. Thus, the data latched in each of the latch circuits LA1 to LA6 is shifted based on the scan clock SANCK, and is serially outputted from the output terminal LQ6 of the holding circuit 15, eventually. Specifically, the third to the first serial output data outputted from the holding circuits 15A to 15C in FIG. 8 is serially outputted from the output terminal LQ6 of the holding circuit 15.

2.3. Operation

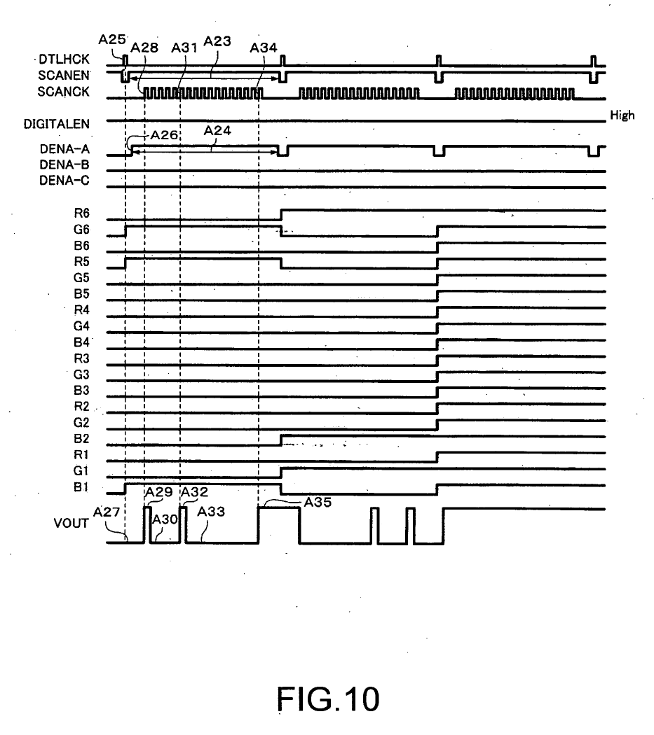

The operation of a display driver 110 according to the embodiment will now be described using the timing chart in FIG. 10. The explanation of the operation in the normal operation mode is not given because the operation is the same with that in FIG. 5 of the first embodiment. The operation of the display driver 110 in the test mode will now be described using FIG. 10. The digital output enable signal DIGITALEN inputted to the mode selector 60 is set active in the test mode for testing the display driver 110. Thus, as mentioned above, the data inputted into the input terminal MIN6 of the mode selector 60 in FIG. 8 is outputted, in common, from the output terminals MQ1 to MQn.

The scan enable signal SCANEN is set active, for example, in the period shown at A23. Thus, the data of each bit is serially outputted from the output terminal LQ6 of the holding circuits 15A to 15C based on the scan clock SCANCK. Further, the multiplexer control signal DENA-A is set active (for example, at high level) in the period shown at A24, for example. Thus, in the period shown at A24, the data inputted into the input terminal AIN6 of the multiplexer 70 is inputted into the input terminal MIN6 of the mode selector 60 via the output terminal PQ6. In the test mode, the multiplexer control signals DENA-B and DENA-C are set non-active (for example, at low level).

For example, when the clock DTLHCK arises at the timing of A25, each of the holding circuits 15A to 15C holds the inputted display data for each pixel. Then, when the multiplexer control signal DENA-A arises at the timing of A26, the multiplexer 70 outputs the output from the output terminal PQ6 of the multiplexer 70 to the mode selector 60. At this moment, the data R6 of the sixth bit for R pixel that is outputted from the output terminal LQ6 of the holding circuit 15A is inputted into the input terminal MIN6 of the mode selector 60. At this timing, the data R6 of the sixth bit is of low level according to FIG. 10. Specifically, a low level voltage is inputted into the input terminal MIN6 of the mode selector 60, and a low level voltage is inputted into each of the input terminals DAIN1 to DAIN6 of the D/A converter 20. Thus, the D/A converter 20 outputs a low level voltage from the output terminal DAQ as a gray scale voltage, and the low level voltage shown at A27 is outputted from the drive voltage output terminal VOUT.

Next, when the scan clock SCANCK arises at the timing of A28, the holding circuits 15A outputs the data R5 of the fifth bit for R pixel from the output terminal LQ6 via the multiplexer 70 to the mode selector 60. At this timing, the data R5 of the fifth bit is of high level according to FIG. 10. Specifically, a high level voltage is inputted into the input terminals DAIN1 to DAIN6 of the D/A converter 20 via the mode selector 60. Thus, the D/A converter 20 outputs a high level voltage from the output terminal DAQ as a gray scale voltage, and the drive voltage shown at A29 is outputted from the drive voltage output terminal VOUT.

Then, the data of the fourth to the first bit R4 to R1 for R pixel is sequentially outputted from the output terminal LQ6 of the holding circuit 15A according to the arising of the scan clock SCANCK. The gray scale voltage is outputted from the D/A converter 20 based on the output from the holding circuit 15A, and the low level voltage shown at A30 is outputted from the drive voltage output terminal VOUT.

From the output terminal LQ6 of the holding circuit 15A, after the data R1 of the first bit for R pixel is outputted, the data G6 of the sixth bit for G pixel is outputted according to the arising of the scan clock SCANCK at the timing of A31, for example. At this timing, the data G6 of the sixth bit for G pixel is of high level according to FIG. 10. Thus, the D/A converter 20 outputs the high level voltage from the output terminal DAQ as a gray scale voltage, and the drive voltage shown at A32 is outputted from the drive voltage output terminal VOUT.

Then, from the output terminal LQ6 of the holding circuit 15A, the data of the fifth to the first bit G5 to G1 for G pixel is sequentially outputted according to the arising of the scan clock SCANCK. Then, from the output terminal LQ6 of the holding circuit 15A, the data of the sixth to the second bit B5 to B2 is sequentially outputted according to the arising of the scan clock SCANCK. The gray scale voltage is outputted from the D/A converter 20 based on the output from the holding circuit 15A, and the low level voltage shown at A33 is outputted from the drive voltage output terminal VOUT.

Then, when the scan clock SCANCK arises at the timing of A34, the holding circuit 15A outputs the data B1 of the first bit for B pixel from the output terminal LQ6 via the multiplexer 70 to the mode selector 60. At this timing, the data B1 of the first bit for B pixel is of high level according to FIG. 10. Thus, the D/A converter 20 outputs a high level voltage from the output terminal DAQ as a gray scale voltage, and the drive voltage shown at A35 is outputted from the drive voltage output terminal VOUT.

In this way, the voltage based on the first to the sixth bit data of the display data for each pixel R1 to R6, G1 to G6 and B1 to B6 is sequentially outputted from the drive voltage output terminal VOUT based on the scan clock SCANCK. The order in which the data is outputted is, for example, from R6 to R1, then from G6 to G1 and then from B6 to B1.

For example, in the period shown at A23, if high level is defined as “1” and low level is defined as “0”, the display data of 6 bits for R pixel can be described as (010000), the display data of 6 bits for G pixel can be described as (100000), and the display data of 6 bits for B pixel can be described as (000001).

In accordance with the above-mentioned order of data, the data outputted from the drive voltage output terminal VOUT in the test mode can be described as (010000100000000001). Specifically, A29 shows that the data R5 is of high level, A32 shows that the data G6 is of high level, and A35 shows that the data B1 is of high level. In this way, in the test mode, the value of the display data for each pixel R1 to Rn, G1 to Gn and B1 to Bn can be read out by detecting the pulse that is outputted from the drive voltage output terminal VOUT.

As mentioned above, in the test mode, the display data of 6 bits for each pixel that is stored in the holding circuits 15A to 15C is outputted from the drive voltage output terminal VOUT as digital serial data. Here, the display driver 110 also can be tested in the same way with that for the display driver 100. The test flow shown in FIG. 6, for example, can be also applied to the display driver 110 according to the second embodiment.

### 3. Comparative Example and Effects

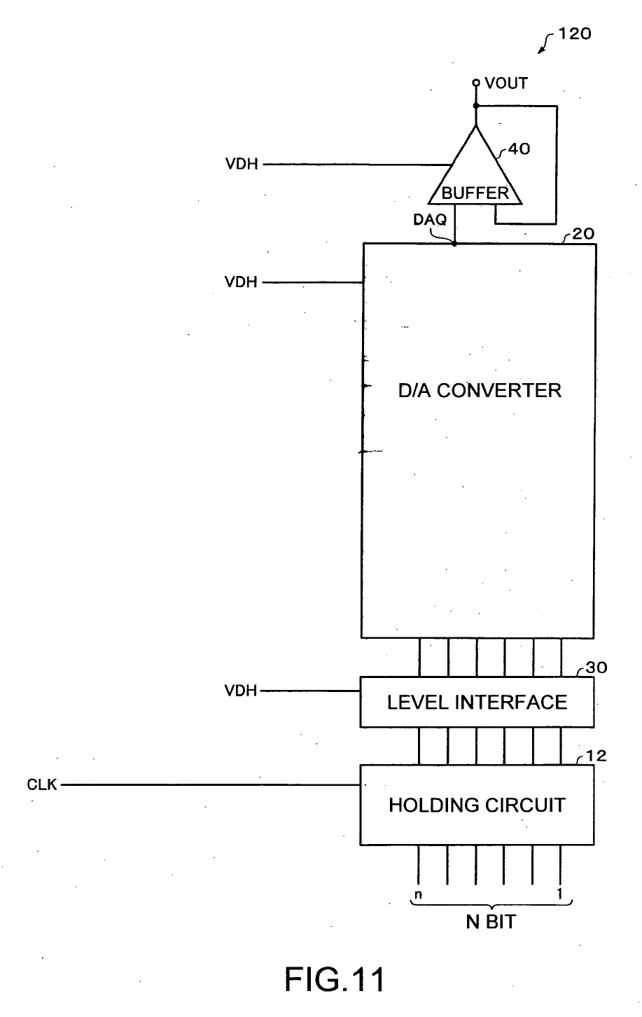

FIG. 11 is a diagram showing a comparative example of a display driver according to the first and second embodiments. The display driver 120 in the comparative example includes a holding circuit 12, a D/A converter 20, a level interface 30 and a buffer 40, although it is not limited to such. For example, a configuration without a level interface 30 is also acceptable for the display driver 120. The holding circuit 12 latches and outputs the display data of n bits based on the clock CLK. The outputted display data of n bits is inputted into the D/A converter 20, for example, via the level interface 30. The D/A converter 20 D/A converts the inputted display data and outputs a gray scale voltage from the output terminal DAQ. The gray scale voltage is outputted from the drive voltage output terminal VOUT via the buffer 40.

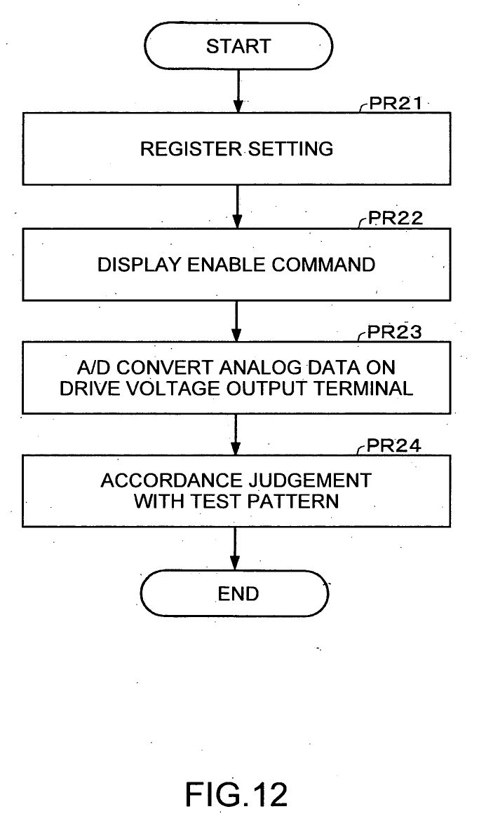

An example of a test flow of a display driver 120 with an above-mentioned configuration is shown in FIG. 12. In the process PR21, preferences for an internal resistor of the display driver 120 are set. Next in the process PR22, a display enable command is sent out to the display driver 120. By the display enable command, the display data for each pixel is outputted to the holding circuit 12 of the display driver 120 from the display memory in which the display data is stored, for example. Thus, the drive voltage is outputted from the drive voltage output terminal VOUT of the display driver 120.

Next, in the process PR23, the drive voltage is D/A converted for testing the drive voltage that is outputted from the drive voltage output terminal VOUT of the display driver 120 in the PR22 process.

Next, in the process PR24, a matching analysis is carried out comparing the display data after the D/A conversion in the process PR23 and the test pattern for the display data that has been set in advance. By this matching analysis, various things such as whether the display driver 100 operates as designed and the like can be analyzed.

In the above-mentioned method, however, there are some problems. For example, in the above-mentioned method, the drive voltage outputted from the drive voltage output terminal VOUT of the display driver 120 needs to be D/A converted and accuracy is required for the D/A conversion. Further, the D/A conversion required for every pixel in the testing prevents the test time from being cut down. Moreover, the improving of the test accuracy is difficult because accurate data is difficult to obtain even if the drive voltage is D/A converted, as for the display driver for driving high-resolution and high-gray scale display panels in recent years, while more accuracy is required in the D/A converting of the drive voltage as gradient gets higher.

Therefore, the above-mentioned problems have a negative impact on the cutting down of production cost as well as on the providing of a high quality display driver.

Meanwhile, the display driver 100 according to the first embodiment and the display driver 110 according to the second embodiment can resolve the above-mentioned problems. In the display drivers 100 and 110, the test mode can be set. In the case where the test mode is set, the display data for a plurality of pixels is outputted as digital data from the drive voltage output terminal VOUT of the display drivers 100 and 110. Thus, when a matching analysis is carried out comparing the display data that has been set as a test pattern in advance and the display data outputted from the drive voltage output terminal VOUT, highly accurate testing is possible because the matching analysis can be carried out between digital data. Further, the test accuracy is not lowered even in the case where the display drivers 100 and 110 carry out high gray scale display, because the comparison is carried out between digital data, meaning that only the value of digital data gets larger. Specifically, the test can be carried out with high accuracy even in the case where the display drivers 100 and 110 support high gray scale display.

The display driver 100 according to the first embodiment and the display driver 110 according to the second embodiment, in the test mode, can output the display data for a plurality of pixels from the drive voltage output terminal VOUT as digital serial data. Thus, the effect of cutting down the test time and improving the test accuracy gets further improved as compared with the comparative example.

The embodiments of the invention have been described above in detail, although it may be easily understood by persons skilled in the art that many kinds of modification are possible. These modification examples are all covered in the invention. For example, the terms that are written, at least once, with other terms having a broader or an equivalent meaning in the specifications and the drawings can be replaced by that other term in any place in the specifications and the drawings.

### 4. Modified Example

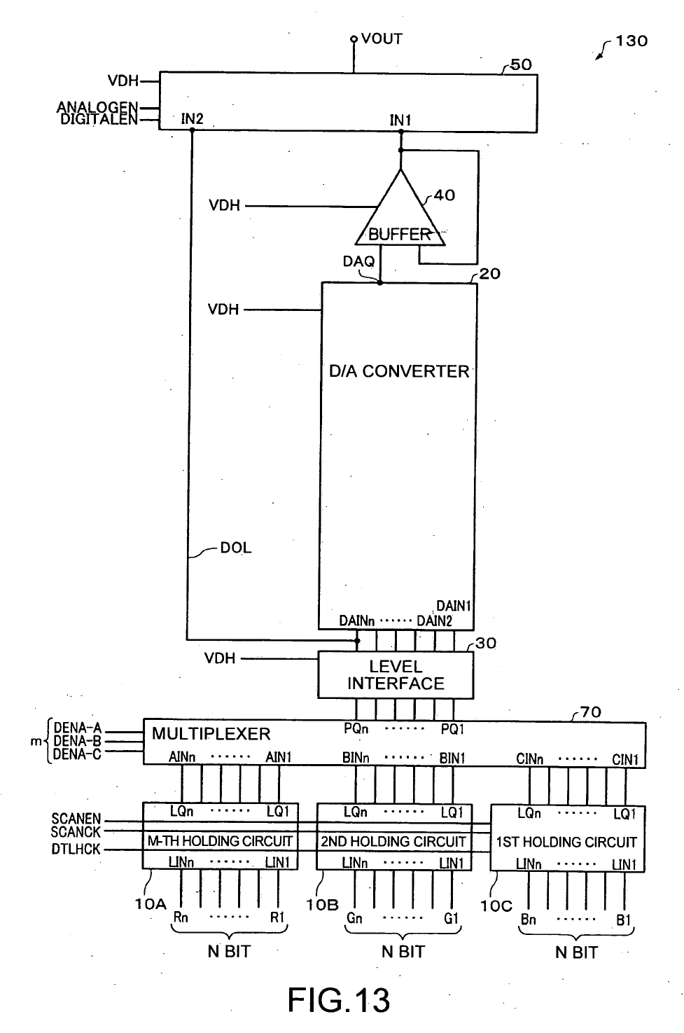

FIG. 13 is a diagram showing a display driver 130, which is a modified example of a display driver 100 according to the first embodiment. In the display driver 130, an output selector 50 and a digital output line DOL are added to the display driver 100 in FIG. 1, and a mode selector 60 is left out from the display driver 100. The other parts in the configurations are the same.

The output selector 50 includes an input terminal IN1 (the first input terminal, in general) that receives voltage based on the gray scale voltage outputted from the output terminal DAQ of the D/A converter 20, another input terminal IN2 (the second input terminal, in general) to which a digital output line DOL is connected, and a drive voltage output terminal VOUT. Here, the voltage is supplied to the digital output line DOL based on the output from the output terminal PQn of the multiplexer 70.

The output selector 50 receives an analog output enable signal ANALOGEN and a digital output enable signal DIGITALEN to switch the voltage to be outputted to the drive voltage output terminal VOUT based on these signals ANALOGEN and DIGITALEN.

Specifically, when the analog output enable signal ANALOGEN is set active and the digital output enable signal DIGITALEN is set non-active, the output selector 50 outputs a gray scale voltage that is inputted into the input terminal IN1 to the drive voltage output terminal VOUT. On the other hand, when the analog output enable signal ANALOGEN is set non-active and the digital output enable signal DIGITALEN is set active, the output selector 50 selects the input terminal IN2. Thus, the voltage supplied from the digital output line DOL that is connected to the input terminal IN2 is outputted from the drive voltage output terminal VOUT.

In the test mode, the analog output enable signal ANALOGEN, for example, is set non-active, the digital output enable signal DIGITALEN is set active, and the scan enable signal SCANEN that is inputted into each of the holding circuits 10A to 10C is set active. Thus, the voltage corresponding to the data of each bit of the display data for each pixel is outputted in a time-sharing way from the drive voltage output terminal VOUT, for example, per one bit (in general, per predetermined number of bits). Specifically, the display data for each pixel can be obtained from the drive voltage output terminal VOUT as digital serial data in the test mode.

Meanwhile, in the case where the output selector 50 selects the input terminal IN2 and at the same time the scan enable signal SCANEN is set non-active, the voltage corresponding to the data of the n-th bit of the display data of n bits for each pixel is outputted from the drive voltage output terminal VOUT. This is effective in the case of supporting the digital gray scale display of the display panel. In digital gray scale display, the display panel is driven by a high level or a low level voltage that is outputted from the drive voltage output terminal VOUT. For example, in the case where one dot of the display panel is composed of three pixels, R pixel, G pixel and B pixel, the color display with eight tones can be achieved because each pixel can render two tones in digital gray scale display.

In the embodiment, by setting the digital output enable signal DIGITALEN and the analog output enable signal ANALOGEN in the normal operation mode, the analog gray scale display or the digital gray scale display can be supported in the display panel.

Here, the configuration of the digital output line DOL is not limited to the above-mentioned one. It is sufficient if the signal corresponding to the data outputted from the output terminal LQn of each of the holding circuits 10A to 10C is inputted into the input terminal IN2 of the output selector 50.

In the case where the analog output enable signal ANALOGEN and the digital output enable signal DIGITALEN are set non-active, the output selector 50 does not output the voltage from the output selector 50, both of the input terminals IN1 and IN2 being unselected. In this case, the drive voltage output terminal VOUT can be set to high impedance, for example. Specifically, the display driver 130 can be set so that a gray scale voltage generated by the D/A conversion may not be outputted to the display panel.

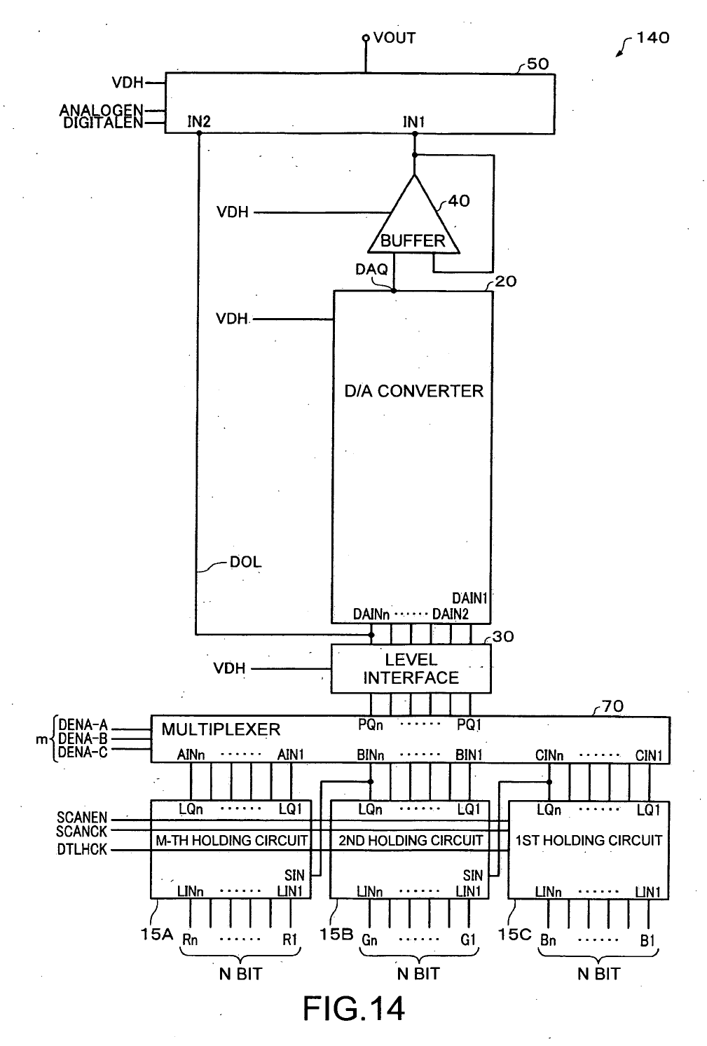

FIG. 14 is a diagram showing a display driver 140, which is a modified example of a display driver 110 according to the second embodiment. In the display driver 140, an output selector 50 and a digital output line DOL are added to the display driver 110 in FIG. 8, and a mode selector 60 is left out from the display driver 110. The other parts in the configurations are the same. Further, the output selector 50 and the digital output line DOL are the same in FIG. 13, and the display driver 140 has the same working effect with the display driver 130 in FIG. 13.

In the test mode, the analog output enable signal ANALOGEN, for example, is set non-active, the digital output enable signal DIGITALEN is set active, and the scan enable signal SCANEN that is inputted into each of the holding circuits 10A to 10C is set active. Thus, the voltage corresponding to the data of each bit of the display data for each pixel is sequentially outputted from the drive voltage output terminal VOUT. Specifically, the display data for each pixel can be obtained from the drive voltage output terminal VOUT as digital serial data in the test mode.

What is claimed is:

1. A display driver, comprising:
first to m-th holding circuits (m is an integer greater than or equal to 2) each of which holds and outputs display data of n bits (n is an integer greater than or equal to 2) for at least one pixel;
a multiplexer that receives display data for a plurality of pixels that is outputted from the first to the m-th holding circuits and time-sharingly outputs the display data for a plurality of pixels in a normal operation mode; and
a D/A converter that, having first to n-th D/A converting input terminals, carries out D/A conversion based on data of n bits that is inputted via the first to the n-th D/A converting input terminals and outputs the output as a gray scale voltage, wherein each of the first to the m-th holding circuits includes first to n-th latch circuits for latching data of each bit of the display data of n bits, the multiplexer includes first to n-th multiplexer output terminals, and, in a test mode for testing the display data, each of the first to the m-th holding circuits serially outputs the display data of n bits that is held in each of the holding circuits as first to m-th serial output data from the output from the n-th latch circuit that is held in each of the holding circuits, the multiplexer time-sharingly outputs the first to the m-th serial output data from the n-th multiplexer output terminal, the first to the m-th serial output data is time-sharingly inputted into each of the first to the n-th D/A converting input terminals via the n-th multiplexer output terminal, and the D/A converter carries out D/A conversion every time the data of each bit of the first to the m-th serial output data inputted into the first to the n-th D/A converting input terminals is inputted and outputs the gray scale voltage.

2. The display driver according to claim 1, wherein:
each of the first to the m-th holding circuits outputs the display data that is latched in the first to the n-th latch circuits to the multiplexer based on the scan enable signal,
the data of the first to the n-th bit that is held in the first to the n-th latch circuits is outputted to the multiplexer via each of the different output lines in the case where the scan enable signal is set non-active, and
the data of the first to the n-th bit is outputted from the output terminal of the n-th latch circuit to the multiplexer as serial output data in the case where the scan enable signal is set-active.

3. The display driver according to claim 2, wherein each of the first to the m-th holding circuits further includes first to (n−1)-th scan switch circuits, wherein the k-th (k is an integer greater than or equal to 1) scan switch circuit among the first to the (n−1)-th scan switch circuits, receiving the output from the k-th latch circuit among the first to the n-th latch circuits and the data of the (k+1)-th bit among the display data, outputs the output from the k-th latch circuit to the (k+1)-th latch circuit in the case where the scan enable signal is set active and outputs the output of the (k+1)-th bit to the (k+1)-th latch circuit in the case where the scan enable signal is set non-active.

4. A display driver, comprising:
first to m-th holding circuits (m is an integer greater than or equal to 2) each of which holds and outputs display data of n bits (n is an integer greater than or equal to 2) for at least one pixel;
a multiplexer that receives display data for a plurality of pixels that is outputted from the first to the m-th holding circuits and time-sharingly outputs the display data for a plurality of pixels in a normal operation mode; and
a D/A converter that, having first to n-th D/A converting input terminals, carries out D/A conversion based on data of n bits that is inputted via the first to the n-th D/A converting input terminals and outputs the output as a gray scale voltage, wherein each of the first to the m-th holding circuits includes first to n-th latch circuits for latching data of each bit of the display data of n bits, the multiplexer includes first to n-th multiplexer output terminals, and, in a test mode for testing the display data, each of the first to the m-th holding circuits serially outputs the display data of n bits that is held in each of the holding circuits as first to m-th serial output data from the output from the n-th latch circuit that is held in each of the holding circuits, with the first to the m-th serial output data being sequentially outputted from the output from the n-th latch circuit of the n-th multiplexer output terminal, the multiplexer outputs the first to the m-th serial output data to the n-th multiplexer output terminal, with the first to the m-th serial output data being sequentially inputted via the n-th multiplexer output terminal to each of the first to the n-th D/A converting input terminals, and the D/A converter carries out D/A conversion every time the data of each bit of the first to the m-th serial output data inputted into the first to the n-th D/A converting input terminals is inputted and outputs the gray scale voltage.

5. The display driver according to claim 4, wherein the multiplexer does not output the data that is inputted from the output from the first to the (m−1)-th holding circuits among the first to the m-th holding circuits to the first to the n-th multiplexer output terminals in the test mode.

6. The display driver according to claim 4, wherein:
at least each of the second to the m-th holding circuits among the first to the m-th holding circuits includes a serial data input terminal to which the output from the n-th latch circuit of the last stage latch circuit is connected in the test mode,
each of the first to the m-th holding circuits outputs the display data that is latched in the first to the n-th latch circuits in each of the first to the m-th holding circuits to the multiplexer based on the scan enable signal, and
in the test mode, the scan enable signal is set active and each of the first to the m-th holding circuits outputs the display data of n bits as serial output data from the output terminal of the n-th latch circuit while the serial output data that is outputted from the output terminal of the n-th latch circuit of the last stage latch circuit is inputted into the serial data input terminal of the second to the m-th holding circuits and the first to the m-th serial output data is sequentially outputted to the multiplexer from the output terminal of the n-th latch circuit of the m-th holding circuit.

7. The display driver according to claim 6, wherein each of the first to the m-th holding circuits further includes first to (n−1)-th scan switch circuits and a serial output data switch circuit, wherein the k-th (k is an integer greater than or equal to 1) scan switch circuit among the first to the (n−1)-th scan switch circuits, receiving the output from the k-th latch circuit among the first to the n-th latch circuits and the data of the (k+1)-th bit among the display data, outputs the output from the k-th latch circuit to the (k+1)-th latch circuit in the case where the scan enable signal is set active and outputs the data of the (k+1)-th bit to the (k+1)-th latch circuit in the case where the scan enable signal is set non-active, and the serial output data switch circuit included in the l-th (l is an integer greater than or equal to 2) holding circuit among the first to the m-th holding circuits, receiving the output from the n-th latch circuit of the (l−1)-th holding circuit and the data of the first bit among the display data, outputs the output from the n-th latch circuit of the (l−1)-th holding circuit to the second latch circuit in the case where the scan enable signal is set active and outputs the data of the first bit of the display data to the second latch circuit in the case where the scan enable signal is set non-active.

8. The display driver according to claim 1, wherein:
a display driver includes a mode selector that outputs the inputted data while switching the output route between in the normal operation mode and in the test mode,
the mode selector includes first to n-th mode selector input terminals that are connected to the first to the n-th multiplexer output terminal of the multiplexer and first to n-th mode selector output terminals for outputting the display data inputted from the multiplexer, and
in the test mode, the mode selector, receiving the digital output enable signal that is set active, electrically connects the n-th mode selector input terminal, among the first to the n-th mode selector input terminals, that receives the serial output data that is outputted from the n-th multiplexer output terminal of the multiplexer to each of the first to the n-th mode selector output terminals, and outputs the serial output data from the n-th latch circuit to the first to the n-th mode selector output terminals.

9. The display driver according to claim 8, wherein the mode selector includes first to (n−1)-th mode selector switch circuits, wherein the k-th (k is an integer greater than or equal to 1) mode selector switch circuit among the first to the (n−1)-th mode selector switch circuits, receiving the output from the k-th multiplexer output terminal that is connected to the k-th mode selector input terminal and the output from the n-th multiplexer output terminal that is connected to the n-th mode selector input terminal, outputs the output from the n-th multiplexer output terminal to the k-th mode selector output terminal in the case where the digital output enable signal is set active and outputs the output form the k-th multiplexer output terminal to the k-th mode selector output terminal in the case where the digital output enable signal is set non-active.

10. A display driver, comprising:
first to m-th holding circuits each of which holds and outputs display data for at least one pixel;
a multiplexer that receives display data for a plurality of pixels that is outputted from the first to the m-th holding circuits and time-sharingly outputs the display data for a plurality of pixels in a normal operation mode;
a D/A converter that carries out D/A conversion for the display data that is outputted from the multiplexer and outputs the output as a gray scale voltage; and
an output selector in which the gray scale voltage based on the output from the D/A converter is inputted to a first input terminal and which outputs a drive voltage to the drive voltage output terminal,
wherein each of the first to the m-th holding circuits includes first to n-th (n is an integer greater than or equal to 2) latch circuits for latching data of each bit of the display data for one pixel, and, in the normal operation mode, the multiplexer time-sharingly outputs the display data for a plurality of pixels per pixel and outputs the data of each bit of the display data for each pixel through different wirings, the D/A converter outputs the gray scale voltage based on the display data for one pixel that is outputted from the multiplexer, the output selector outputs the drive voltage from the drive voltage output terminal based on the gray scale voltage that is inputted into the first input terminal, and, in the test mode for testing the display data, each of the first to the m-th holding circuits serially outputs the data latched in the first to the n-th latch circuits from the output from the n-th latch circuit as serial output data while the serial output data that is outputted from each of the first to the m-th holding circuits is inputted into the second input terminal of the output selector via the multiplexer and the output selector outputs voltage based on the data of each bit of the serial output data that is inputted into the second input terminal to the drive voltage output terminal.

11. The display driver according to claim 10, wherein the multiplexer time-sharingly outputs the serial output data for each pixel that is outputted from each of the first to the m-th holding circuits per predetermined number of pixels in the test mode.

12. The display driver according to claim 10, wherein each of the first to the m-th holding circuits outputs the display data that is latched in the first to the n-th latch circuits to the multiplexer based on the scan enable signal, outputting the data of the first to the n-th bit that is held in the first to the n-th latch circuits to the multiplexer via different output lines in the case where the scan enable signal is set non-active and outputting the data of the first to the n-th bit from the output terminal of the n-th latch circuit to the multiplexer as serial output data in the case where the scan enable signal is set active.

13. The display driver according to claim 10, wherein the multiplexer includes first to n-th multiplexer output terminals for outputting the display data, wherein in the test mode the first to the m-th serial output data that is outputted as serial output data from each of the first to the m-th holding circuits is sequentially outputted from the n-th latch circuit of the m-th holding circuit while at least the first to the m-th serial output data that is sequentially outputted from the n-th latch circuit of the m-th holding circuit, among the data outputted from the m-th holding circuit, is outputted to the n-th multiplexer output terminal.

14. The display driver according to claim 10, wherein at least each of the second to the m-th holding circuits among the first to the m-th holding circuits includes a serial data input terminal to which the output from the n-th latch circuit of the last stage holding circuit is connected in the test mode, wherein each of the first to the m-th holding circuits outputs the display data that is latched in the first to the n-th latch circuits to the multiplexer based on the scan enable signal, wherein each of the first to the m-th holding circuits outputs the first to the n-th bit data that is held in the first to the n-th latch circuits to the multiplexer via different output lines in the normal operation mode, when the scan enable signal is set non-active, while in the test mode, when the scan enable signal is set active, each of the first to the m-th holding circuits outputs the data of the first to the n-th bit from the output terminal of the n-th latch circuit as serial output data, the serial output data that is outputted from the output terminal of the n-th latch circuit of the last stage holding circuit is inputted into the serial data input terminal of the second to the m-th holding circuits, and the first to the m-th serial output data is sequentially outputted to the multiplexer from the output terminal of the n-th latch circuit of the m-th holding circuit.

15. The display driver according to claim 10, wherein a digital signal output line is placed between the output selector and the multiplexer, and each of the first to the n-th latch circuits of the first to the m-th holding circuits stores the data of the first to the n-th bit of the display data, and the output from the multiplexer is inputted into the second input terminal of the output selector via the digital signal output line, wherein the scan enable signal that is inputted into the first to the m-th holding circuits is set active in the test mode and each of the data of the first to the n-th bit of each of the first to the m-th holding circuits is outputted as the serial output data from the output terminal of the n-th latch circuit of each of the first to the m-th holding circuits, the serial output data that is outputted from each of the first to the m-th holding circuits is inputted into the second input terminal of the output selector via the multiplexer and the digital signal output line, and the output selector outputs the voltage from the drive voltage output terminal based on the serial output data that is inputted into the second input terminal.
